(19) United States
(12) Patent Application Publication
(10) Pub. No.: US 2020/0375405 A1
(43) Pub. Date: Dec. 3, 2020

(54) Scalable automatic kitchen

(71) Applicant: Zhengxu He, Reno, NV (US)

(72) Inventor: Zhengxu He, Reno, NV (US)

(21) Appl. No.: 16/997,933

(22) Filed: Aug. 20, 2020

Related U.S. Application Data
(63) Continuation-in-part of application No. 16/517,705, filed on Jul. 22, 2019.
(60) Provisional application No. 62/810,280, filed on Feb. 25, 2019.

(51) Int. Cl. A47J 44/00; A47J 47/01; A47J 47/02; A47J 36/32; G05B 19/4155; B25J 15/10; B25J 5/00; B25J 11/00; F25D 13/06

(52) U.S. Cl. CPC A47J 44/00; A47J 47/01; A47J 47/02; A47J 36/321; G05B 2219/39172; B25J 15/10; B25J 5/00; B25J 11/0045; F25D 13/06; G05B 19/4155

(57) ABSTRACT

The present application discloses a scalable automated kitchen system comprising: ingredient containers configured to contain or otherwise hold food ingredients wherein some ingredient containers may be closed by lids such as caps; storage room configured to store ingredient containers; lid opening apparatus configured to remove a lid from a closed container; transfer apparatus configured to move a closed ingredient container from storage area to the lid opening apparatus; cooking stations configured to cook food; a transport system comprising rail tracks and vehicles moving on the rail tracks configured to transport ingredient containers, stopping mechanisms, charging mechanisms, and track switch mechanisms. The automated kitchen system can save labor cost and can produce cooked food of consistent quality.

This application is a continuation-in-part of U.S. patent application Ser. No. 16/517,705, filed Jul. 22, 2019, which claims the benefit of U.S. Provisional Application Ser. No. 62/810,280, filed Feb. 25, 2019. Entire contents of the above applications are hereby incorporated herein by reference.

### CROSS-REFERENCE TO RELATED APPLICATIONS

### U.S. Provisional Patent Application

Ser. No. 62/810,280; Filed Feb. 25, 2019; Inventor: Zhengxu He.

### U.S. Patent Applications

Ser. No. 15/706,136, filed Sep. 15, 2017, Inventor: Zhengxu He
Ser. No. 15/157,319, filed May 17, 2016, Inventor: Zhengxu He (U.S. Pat. No. 10,455,987)
Ser. No. 15/801,923, filed Nov. 2, 2017, Inventor: Zhengxu He
Ser. No. 15/798,357, filed Oct. 30, 2017, Inventor: Zhengxu He
Ser. No. 16/155,895, filed Oct. 10, 2018, Inventor: Zhengxu He
Ser. No. 16/510,982, filed Jul. 15, 2019, Inventor: Zhengxu He
Ser. No. 16/517,705, filed Jul. 22, 2019, Inventor: Zhengxu He
Ser. No. 16/997,196, filed Aug. 19, 2020, Inventor: Zhengxu He

### BACKGROUND OF THE INVENTION

The present application relates to automatic control techniques for storage, transportation and dispensing of food ingredients into a cookware of a cooking apparatus, and the related automatic control techniques in an automated kitchen.

During cooking of a food item, some ingredients need to be dispensed into a cookware. Traditionally, in commercial settings, food ingredients are packaged into plastic bags or other containers. They are transported to a storage area (often a refrigerator) in a kitchen. Afterwards, these containers are partially, or entirely, handled by humans. The task of obtaining a certain quantity of a type of food ingredients from a large container is very hard and expensive to automate.

One may use vehicles and conveyors to transport a cooked food, with a human handling the loading and dispensing of food containers. Due to cost savings or the necessity to improve food safety, it is desirable to automate the process of transferring and dispensing of the food ingredients from the storage area to a cookware. Furthermore, there is a need for an algorithm to control this and related processes. In our invention, vehicles are used to transport food ingredients, and the loading and dispensing are fully automated.

### BRIEF SUMMARY OF THE INVENTION

The food ingredients are often prepared or processed at a processing location and then transported to a storage area (often a refrigerator) in a kitchen, and then transferred out of the storage area and dispensed into a cookware during cooking. Our automated kitchen system may comprise one or more of the following: ingredient containers which may be closed with caps or lids as to preserve freshness of ingredients; transport carts to contain or otherwise hold closed ingredient containers; a storage apparatus comprising a plurality of compartments each configured to store closed ingredient containers; a lid opening apparatus configured to remove the cap from an ingredient container; a transfer apparatus configured to move an ingredient container from a storage apparatus or from a transport cart to the lid opening location; and a transport system comprising (mini) vehicles; rail tracks for said vehicles.

The automated kitchen system comprises a plurality of cooking stations (or cooking systems), each comprising one or more of the following: a cooking apparatus comprising a cookware configured to contain or otherwise hold food or food ingredients; a stirring motion mechanism configured to produce a motion in the cookware as to stir, mix or distribute the food or food ingredients contained in the cookware during a cooking process; and a dispensing apparatus configured to dispense the food ingredients from an ingredient container which is located at a certain position into the cookware.

Each apparatus or mechanism of the automated kitchen system may comprise: electrical or electronic devices including but not limited to: motors, refrigeratorrefrigeration machines, shut-off valves; inductive or other types of stoves, vacuum generators, etc.; sensors including but not limited to encoders, pressure sensors, locational sensors, infrared sensors, temperature sensors or other sensors.

The automated kitchen system may further comprise a computer system comprising a first computer and a plurality of second computers (e.g., microcontrollers or programmable logic controllers commonly known as PLCs), wherein each second computer is configured to be connected to the first computer by wires or by wireless means so that the second computer may communicate with the first computer. Each second computer is configured to be connected to some electrical or electronic devices and sensors, so that the second computer may send and/or receive electrical or electronic signals to and/or from said devices and sensors.

Depending on the type of the electrical or electronic device(s), the connection between a second computer and an electrical or electronic device comprises a wire, a wireless communication device, a controller, a driver, a relay, a breaker, a contractor, and/or a switch. These components may be housed in an electrical cabinet.

In another general aspect, the present invention relates to an algorithm which may control the electrical or electronic devices via the computers.

These and other aspects, their implementations and other features are described in detail in the drawings, the description and the claims.

### BRIEF DESCRIPTION OF THE SEVERAL VIEWS OF THE DRAWINGS

FIG. 1A shows an aerial view of a computer comprising a plurality of input/output ports. FIG. 1B shows an aerial view of another computer which comprises a plurality of input/output ports. FIG. 1C shows an aerial view of a computer system.

FIG. 2A shows an aerial view of a motion mechanism. FIG. 2B shows an aerial view of a linear motion mechanism. FIG. 2C shows an aerial view of a rotational motion mechanism.

FIG. 2D shows an aerial view of a rotational motion mechanism. FIG. 2E shows an aerial view of a combination motion mechanism FIG. 2F shows an aerial view of a combination motion mechanism. FIG. 2G shows an aerial view of a combination motion mechanism FIG. 2H shows an aerial view of a combination motion mechanism. FIG. 2I shows an aerial view of a robot arm.

FIG. 3A shows a side view of an ingredient container. FIG. 3B shows an aerial view of a cap. FIG. 3C shows an aerial view of a lid.

FIG. 4A shows a side view of a closed ingredient container. FIG. 4B shows a side view of a closed ingredient container.

FIG. 5A shows an aerial view of a storage apparatus. FIG. 5B shows a cut view of the storage apparatus.

FIG. 6 shows an aerial view of a transport cart.

FIG. 7A shows an aerial view of a gripper mechanism. FIG. 7B shows an aerial view of a gripper mechanism. FIG. 7C shows an aerial view of a gripper mechanism. FIG. 7D shows an aerial view of a gripper mechanism. FIG. 7E shows an aerial view of a gripper mechanism.

FIG. 8 shows an aerial view of a transfer apparatus.

FIG. 9A shows an aerial view of a container transfer apparatus which grips a closed container. FIG. 9B shows an aerial view of a gripper mechanism. FIG. 9C shows an aerial view of an aerial view of a container transfer apparatus which grips a container. FIG. 9D shows an aerial view of a lid opening sub-apparatus which grips a cap of a container.

FIG. 10 shows an aerial view of a sub-apparatus which grips a container.

FIGS. 11-16 show aerial views of parts of a storage station. FIG. 17A shows an aerial view of the storage station. FIG. 17B shows an aerial view of a lid opening sub-apparatus which grips a cap.

FIG. 18A shows an aerial view of a driving wheel mechanism. FIG. 18B shows an aerial view of a universal wheel mechanism. FIG. 18C shows an aerial view of a vehicle which may move on rail tracks. FIG. 18D shows an aerial view of parts of the vehicle. FIG. 18E shows an aerial view of the vehicle on a pair of rail tracks.

FIG. 19A shows an aerial view of a device. FIG. 19B shows an aerial view of a track switch mechanism (type I). FIG. 20A shows an aerial view of a device. FIG. 20B shows an aerial view of a track switch mechanism (type II).

FIG. 21A shows an aerial view of a stopping device. FIG. 21B shows an aerial view of a stopping device. FIG. 21C shows an aerial view of a stopping device.

FIG. 22 shows an aerial view of a stopping mechanism comprising the stopping device shown in FIG. 21A.

FIG. 23 shows an aerial view of a stopping mechanism comprising the stopping device shown in FIG. 21B.

FIG. 24 shows an aerial view of a stopping mechanism comprising the stopping device shown in FIG. 21C.

FIG. 25A shows an aerial view of a charging sub-mechanism. FIG. 25B shows an aerial view of a charging mechanism.

FIG. 26 shows a plane view of a rail track system comprising: a plurality of rail tracks; a plurality of track switch mechanism of type I; and a plurality of track switch mechanisms (type II). FIGS. 27A-28B show aerial views of parts of the rail track system.

FIG. 29 shows a plane view of a transport system comprising: vehicles; stopping mechanisms; charging mechanisms; and a rail track system.

FIG. 30 shows an aerial view of a container transfer apparatus.

FIG. 31 shows the transfer of an emptied container from a vehicle.

FIG. 32 shows an aerial view of the storage station and a part of the transport system near the storage station.

FIG. 33A shows a cut view of a storage room. FIG. 33B shows a view of a rotational motion mechanism of the storage room. FIG. 33C shows an aerial view of the storage room.

FIG. 34A shows a plane view of the storage room and the storage station and a part of transport system in the storage room. FIG. 34B shows an aerial cut view of the storage room.

FIG. 35 shows an aerial view of a cooking apparatus.

FIG. 36 show aerial views of a transfer apparatus.

FIG. 37 shows an aerial view of a dispensing apparatus configured to dispense food ingredients from an ingredient container

FIGS. 38A-38B show aerial views of a cooking station comprising the cooking apparatus shown in FIG. 35.

FIG. 39 shows a schematic view of a kitchen system comprising the cooking station.

FIG. 40 shows an aerial view of parts of the kitchen system.

FIG. 41 is a flow chart showing the procedures of the transfer of an ingredient container and dispensing of food ingredients from the container to a cookware in the kitchen system.

FIG. 42 is a flow chart showing the procedures of the computer system of the kitchen system in preparation of receiving an order for food item.

FIG. 43 is a flow chart showing the procedures of the computer system of the kitchen system for controlling the cooking of a food item, after a food item is ordered.

### DETAILED DESCRIPTION OF THE INVENTION

For the present patent application, a food ingredient refers to any of the foods or substances that are combined to make a particular food. A food ingredient can be raw or pre-cooked. A food ingredient can be solid, powder, liquid, or a mixture, etc. Examples of food ingredient can be raw meat, sausage, fresh vegetable, dry vegetable, cooking oil, vinegar, soy source, water, or salt, etc.

For the present patent application, a computer system is meant to be any system or apparatus that includes one or more computers. A computer system may or may not include a database. A computer system may or may not include a network. A computer system may or may not include a memory shared by more than one computers. A computer system may include software. A single computer with software can be considered as a computer system.

For the present patent application, a shaft always comprises an axis. A shaft can have different shapes at different sections. A sectional shape of a shaft can be round or rectangular, or of other shapes. For the present patent application, a rotational movement refers to a rotational movement around an axis. A rotational mechanism refers to any mechanism comprising two mating parts which are constrained to rotate relative to each other. An example of rotational mechanism comprises a shaft and a bearing housing as mating parts, wherein the shaft and bearing housing are connected by bearings and accessories.

In some applications or embodiments, a motor comprises a base component (e.g., a frame) which is a stationary member of the motor, and a shaft which is a moving member of the motor, wherein a (usually rotational) motion of the shaft relative to the base component can be produced. A motor may be connected to a computer via wires, and/or through a driver, and/or a controller and/or a relay and/or a wireless communication device. The base component of a motor may be referred to as the support component of the motor.

Similarly, an encoder may comprise a base component, and a shaft which is rotatable relative to the base component, where the encoder can detect the degree of rotation of the shaft relative to the base component, and then inform a computer of the degree by sending signals to the computer.

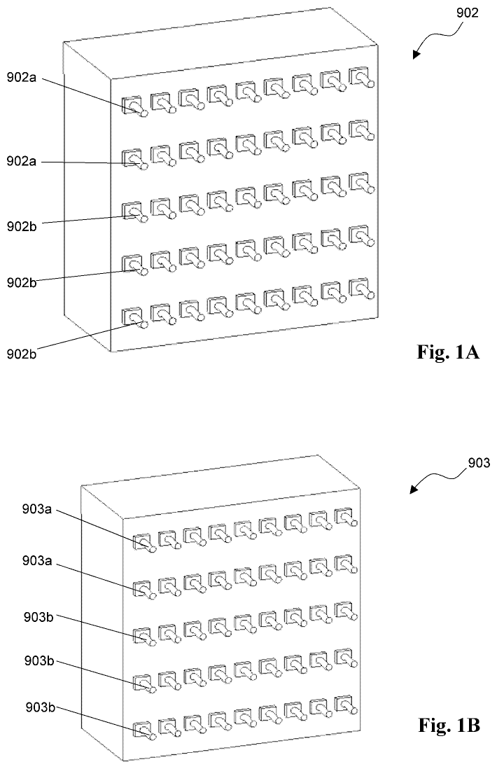

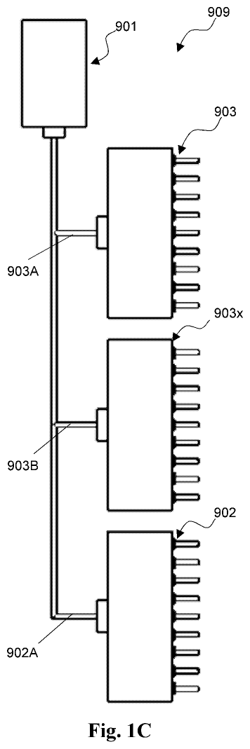

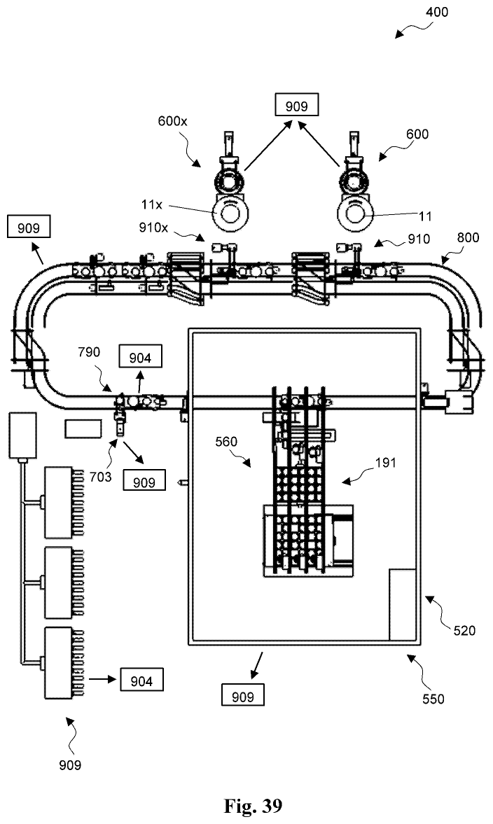

The elements of our invention will be described in detail in FIGS. 1A-38, and they are assembled into an automated kitchen system in FIG. 39.

Referring to FIG. 1A, a computer 902 comprises a plurality of i/o ports 902a and a plurality of i/o ports 902b. The i/o ports 902a of the computer 902 may be connected (either via wires or via wireless communication devices) to sensors, which can be encoders, pressure sensors, proximity switches, micro switches, infrared sensors, temperature sensors, etc., as to allow the computer to communicate with the sensors. The i/o ports 902b of the computer 902 may be connected to electrical or electronic devices, which may comprise motors, stoves, refrigeration apparatus, etc., as to allow the computer to communicate with the electrical or electronic devices. The communications can optionally be one way or two ways (to and from). For example, the signals of the sensors may be sent to the computer 902; the computer 902 may control the operations of the electrical or electronic devices by sending signals to the electrical or electronic devices.

Referring to FIG. 1B, a computer 903 comprises a plurality of i/o 903a and a plurality i/o ports 903b. The i/o ports 903a of the computer 903 may be connected (either via wires or via wireless communication devices) to sensors, and the i/o ports 903b of the computer 903 may be connected to electrical or electronic devices, as to allow the computer to communicate with the electrical or electronic devices. The communications can optionally be one way or two ways (to and from). For example, the computer 903 may control the operations of the electrical or electronic devices by sending signals to the electrical or electronic devices through the i/o ports of the computer 903; the signals of the sensors may be sent back to the computer 903.

It should be noted that the computer 902 or 903 may comprise a programmable logic controller (in short, PLC). The computer 902 or 903 may alternatively comprise a microcontroller, a circuit board, and a plurality of other electronic or electric components which are connected to the circuit board.

Referring to FIG. 1C, a computer system 909 comprises a server 901 as a first computer, and computers 902, 903 and 903x as second computers, wherein the computer 903x is configured identically as the computer 903. The computer 902 can be configured differently than the computer 903. The computers 902, 903 and 903x are connected via wires 902A, 903A and 903B to the server 901, so that digital or analog data may be communicated between the server 901 and any of the computers 902, 903 and 903x. The computer system 909 may control motors, actuators; stoves or heaters; and other devices by known techniques.

It should be noted that the connection between the server 901 and the computer 902, 903 or 903x may be via RS485 wiring, or RS422 or RS232 wiring, etc., or alternatively, via wireless communication devices. The server 901 may be substituted by a PC, or workstation, or other type of computer.

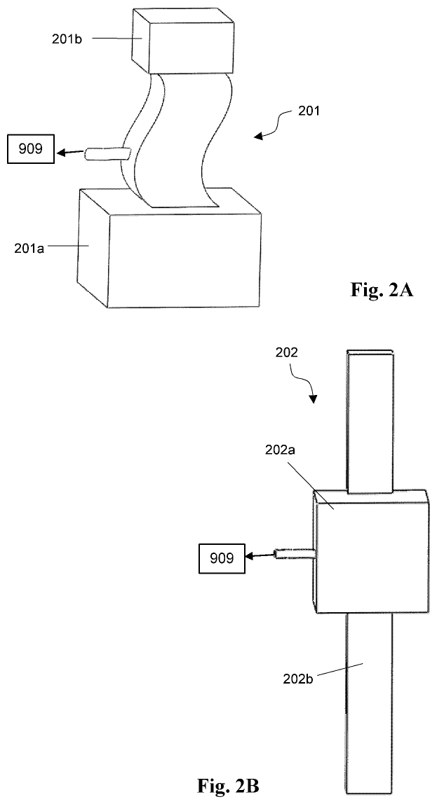

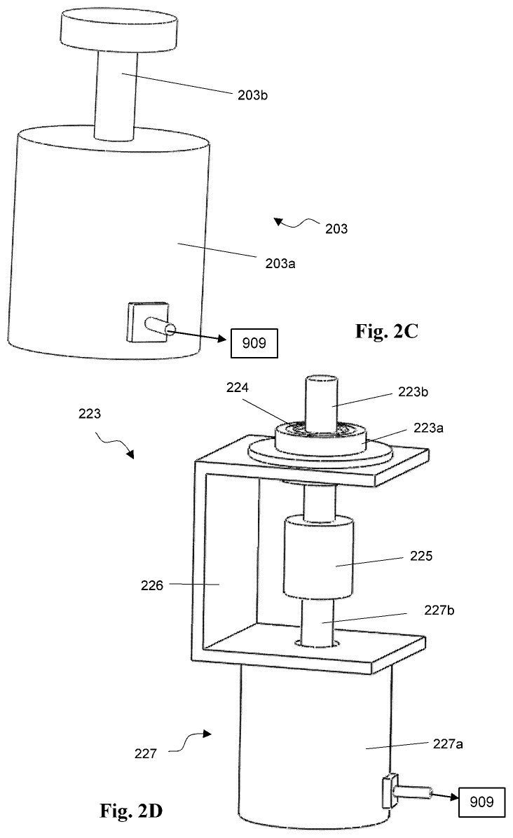

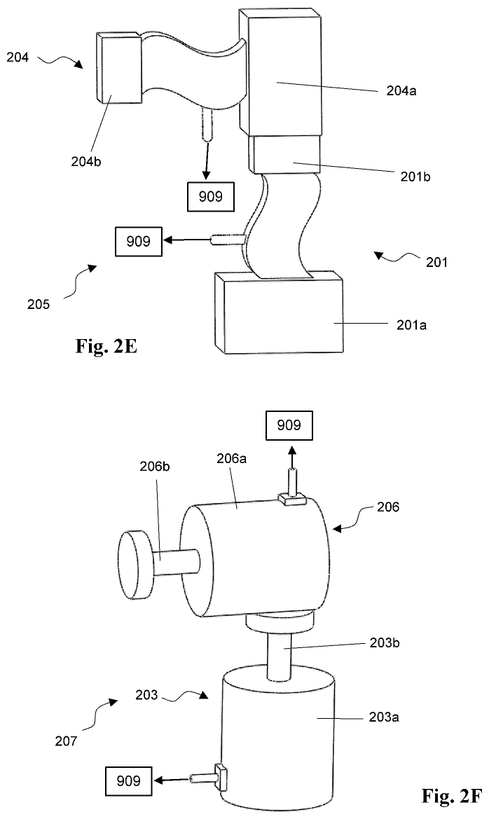

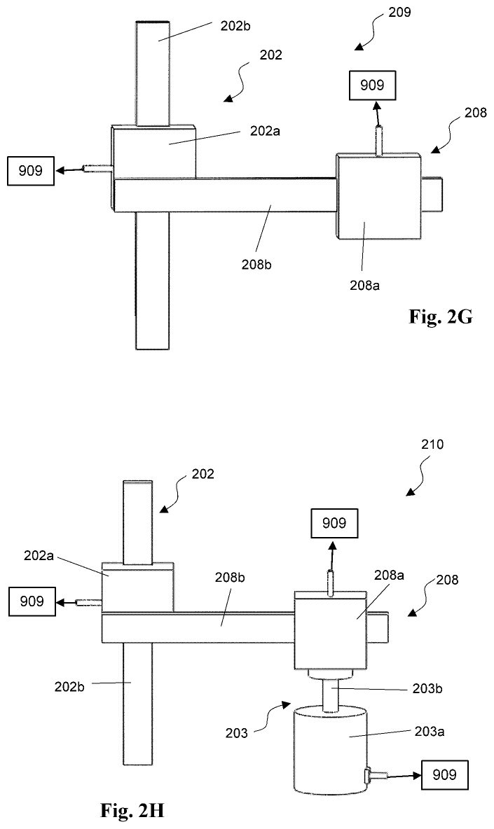

Referring to FIG. 2A, a motion mechanism 201 comprises a stationary member 201a and a moving member 201b, which is connected (but not rigidly connected) to the stationary member. In many applications the movement of the moving member 201b is constrained relative to the stationary member 201a. The motion mechanism 201 comprises a driving mechanism (not shown in figure) configured to produce a motion of the moving member 201b relative to the stationary member 201a. The motion mechanism 201 may be connected to the computer system 909 via wires or by wireless means and the computer system 909 may be configured to control the timing and speed of the motion mechanism 201.

The motion mechanism 201 is a generic motion mechanism. Implicitly, the motion mechanism 201 includes a connection configured to connect the moving member to the stationary member, wherein said connection may often comprise bearings, sliders, kinematic pairs, and/or transmission mechanisms. The driving mechanism may be connected to the computer system 909 (via wires or by wireless means). The driving mechanism may be powered by electricity or other energy sources. A typical example of driving mechanism is a motor.

Referring to FIG. 2B, a linear motion mechanism 202 comprises a stationary member 202a and a moving member 202b, wherein the moving member 202b is constrained to move linearly relative to the stationary member 202a. The linear motion mechanism 202 comprises a driving mechanism (not shown in figure) configured to produce a linear motion of the moving member 202b relative to the stationary member 202a. The linear motion mechanism 202 may be connected to the computer system 909 via wires or by wireless means, and the computer system 909 may be configured to control the timing and speed of the linear motion mechanism 202.

The linear motion mechanism 202 is a generic one. Example of linear motion mechanism includes but are not limited to: a linear actuator; a mechanism comprising linear rail, a slider configured to slide linearly on the linear rail, and a driving mechanism configured to drive the linear motion of the slider; etc.

It should be noted that the linear motion mechanism 202 may comprise a linear actuator. The linear motion mechanism 202 may include a motor which produces a rotational motion and a transmission mechanism configured to convert a rotation into a linear motion; wherein the transmission mechanism may optionally comprise a pair of gear and rack, a pair of screw rod and nut, or a pair of sprocket and chain, etc.

A linear motion mechanism (such as the mechanism 202) is called a vertical motion mechanism if the direction of the linear motion is vertical. A linear motion mechanism (such as the mechanism 202) is called a horizontal motion mechanism if the direction of the linear motion is horizontal.

Referring to FIG. 2C, a rotational motion mechanism 203 comprises a stationary member 203a, a moving member 203b which is constrained to rotate relative to the stationary member 203a. The rotational motion mechanism 203 comprises a driving mechanism (not shown in figure) configured to produce a rotation of the moving member 203b relative to the stationary member 203a around an axis, wherein the axis of the rotation is referred to as the axis of the rotational motion mechanism. The rotational motion mechanism 203 may be connected to the computer system 909 via wires or by wireless means, and the computer system 909 may be configured to control the timing and speed of the rotational motion mechanism 203.

Referring to FIG. 2D, a rotational motion mechanism 223 comprises: a bearing housing 223a as a stationary member; a shaft 223b as a moving member; and a motor 227 as a driving member, i.e., a driving mechanism. The bearing housing 223a and the shaft 223b are connected by bearings 224 and accessories so that the shaft 223b is constrained to rotate relative to the bearing housing 223a. The motor 227 comprises a base component 227a and a shaft 227b so that the motor may produce a rotation of the shaft 227b relative to the stationary member 227a. The base component 227a of the motor is rigidly or fixedly connected to the bearing housing 223a via a connector 226 and the shaft 227b of the motor is connected to the shaft 223a by a coupling 225. It should be clear that the motor 227 may produce a rotation of the shaft 223b relative to the bearing housing 223a. The motor 227 is a driving mechanism of the rotational mechanism 223.

It should be noted that the rotation produced by a rotational motion mechanism may be a continuous rotation, an intermittent motion, or a back-and-forth rotation between two end-positions.

Referring to FIG. 2E, a motion mechanism 205 is a combination of two motion mechanisms 201 and 204, which may also be referred to as motion sub-mechanisms; wherein the motion mechanism 201 is as described as in FIG. 2A; wherein the motion mechanism 204 is a motion mechanism comprising a stationary member 204a and a moving member 204b which is connected to the stationary member 204a, said motion mechanism 204 comprising a driving mechanism (not shown in figure) configured to produce a motion of the moving member 204b relative to the stationary member 204a. The moving member 201b of the motion mechanism 201 is fixedly or rigidly connected to the stationary member 204a of the motion mechanism 201, so the motion mechanism 201 comprising a driving mechanism (not shown in figure) which can produce a motion of the stationary member 204a relative to the stationary member 201a of the motion mechanism 201. The combination motion mechanism 205 may be connected to the computer system 909 in the sense that the motion sub-mechanisms 201 and 204 are connected to the computer system 909 via wires or by wireless means, and the computer system 909 may be configured to control the motions produced by the motion sub-mechanisms of the combination motion mechanism 205.

The motion mechanism 205 is referred to as a combination motion mechanism. It should be noted that the motion sub-mechanisms 201 and 204 may produce motions simultaneously. This applies to any combination motion mechanism in the following. Combination motion mechanisms are special cases of motion mechanisms.

Referring to FIG. 2F, a combination motion mechanism 207 comprises rotational motion mechanisms 203 and 206, referred to as motion sub-mechanisms; wherein the motion mechanism 203 is described in FIG. 2C; wherein the motion mechanism 206 is a rotational motion mechanism comprising a stationary member 206a and a moving member 206b which is constrained to rotate relative to the stationary member 206a, said motion mechanism 206 comprising a driving mechanism (not shown in figure) configured to produce a rotational motion of the moving member 206b relative to the stationary member 206a. The moving member 203b of the motion mechanism 203 is fixedly or rigidly connected to the stationary member 206a of the rotational motion mechanism 206, so the rotational motion mechanism 203 can produce a rotation of the stationary member 206a relative to the stationary member 203a around the axis of the rotational motion mechanism 203. The combination motion mechanisms 207 may be connected to the computer system 909 in the sense that the motion sub-mechanisms 203 and 206 are connected to the computer system 909 via wires or by wireless means, and the computer system 909 may be configured to control the motions produced by the motion sub-mechanisms of the combination motion mechanism 207.

Referring to FIG. 2G, a combination motion mechanism 209 comprises two linear motion mechanisms 202 and 208; wherein the motion mechanism 202 is described in FIG. 2B; wherein the motion mechanism 208 is a linear motion mechanism comprising a stationary member 208a and a moving member 208b which is constrained to move linearly relative to the stationary member 206a, said motion mechanism 208 configured to produce a linear motion of the moving member 208b relative to the stationary member 208a. The moving member 208a of the linear motion mechanism 208 is rigidly or fixedly connected to the stationary member 202a of the linear motion mechanism 202, so the linear motion mechanism 208 can produce a linear motion of the stationary member 202a relative to the stationary member 208a. The combination motion mechanism 209 may be connected to the computer system 909 in the sense that the motion sub-mechanisms 202 and 208 are connected to the computer system 909 via wires or by wireless means, and the computer system 909 may be configured to control the motions produced by the motion sub-mechanisms of the combination motion mechanism 209.

Referring to FIG. 2H, a combination motion mechanism 210 comprises a rotational motion mechanism 203 and two linear motion mechanisms 202 and 208; wherein motion mechanisms 203, 202 and 208 are referred to as motion sub-mechanisms. The moving member 208a of the linear motion mechanism 208 is rigidly or fixedly connected to the stationary member 202a of the linear motion mechanism 202, so the linear motion mechanism 208 can produce a linear motion of the stationary member 202a relative to the stationary member 208a of the linear motion mechanism 208. The moving member 203b is fixedly connected to the stationary member 208a of the linear motion mechanism 208, so the rotational motion mechanism 203 can produce a rotation of the stationary member 208a relative to the stationary member 203a. The combination motion mechanisms 210 may be connected to the computer system 909 in the sense that the motion sub-mechanisms 202, 203 and 208 are connected to the computer system 909 via wires or by wireless means, and the computer system 909 may be configured to control the motions produced by the motion sub-mechanisms of the combination motion mechanism 210.

Referring to FIG. 2I, a robot arm 218 comprises a plurality of rotational motion mechanisms 211, 213, 215 and 217; wherein the motion mechanisms 211, 213, 215 and 217 are referred to as motion sub-mechanisms. The rotational motion mechanism 211, 213, 215 or 217 comprises: a stationary member 211a, 213a, 215, or respectively 217a; a moving member 211b, 213b, 215b, or respectively 217b which is constrained to rotate relative to the respective stationary member; and a driving member comprising a motor (not shown in figure) configured to drive a rotation of the respective moving member relative to the respective stationary member around an axis. The moving member 211b of the rotational motion mechanism 211 is rigidly connected to the stationary member 213a of the rotational motion mechanism 213 via a connector 212; wherein the axis of the rotational motion mechanism 211 may optionally be perpendicular to the axis of the rotational motion mechanism 213. Thus, the motion mechanism 211 can produce a rotation of the stationary member 213a relative to the stationary member 211a. The moving member 213b of the rotational motion mechanism 213 is rigidly connected to the stationary member 215a of the rotational motion mechanism 215 via a rigid connector 214; wherein the axis of the rotational motion mechanism 213 may optionally be parallel to the axis of the rotational motion mechanism 215. The rotational motion mechanism 213 can produce a rotation of the stationary member 215a relative to the stationary member 213a. The moving member 215b of the rotational motion mechanism 215 is rigidly connected to the stationary member 217a of the rotational motion mechanism 217 via a connector 216; wherein the axis of the rotational motion mechanism 215 may optionally be perpendicular to the axis of the rotational motion mechanism 217, and the rotational motion mechanism 215 can produce a rotation of the stationary member 217a relative to the stationary member 215a. The robot arm 218 may be connected to the computer system 909 in the sense that the motion sub-mechanisms 211, 213, 215 and 217 are connected to the computer system 909 via wires or by wireless means, and the computer system 909 may be configured to control the motions produced by the motion sub-mechanisms of the robot arm 218.

The robot arm 218 is a combination motion mechanism which is a combination of the motion sub-mechanisms 211, 213, 215 and 217. Any robot arm of prior art may be used as a motion mechanism for our applications. Any motion mechanism of prior art may be used for our applications.

It should be possible to construct a combination motion mechanism from a rather arbitrary sequence of motion mechanisms, referred to as motion sub-mechanisms.

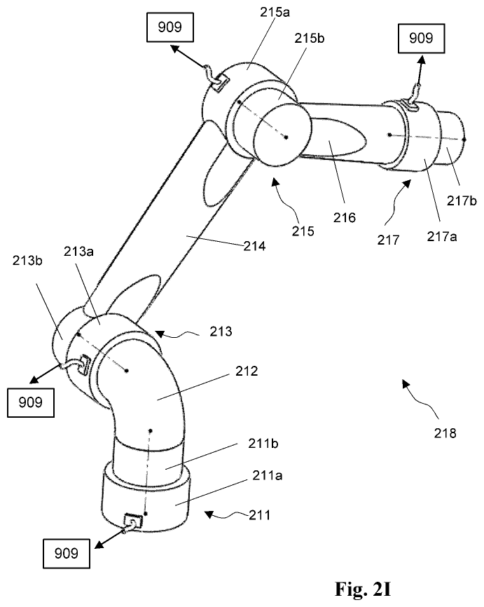

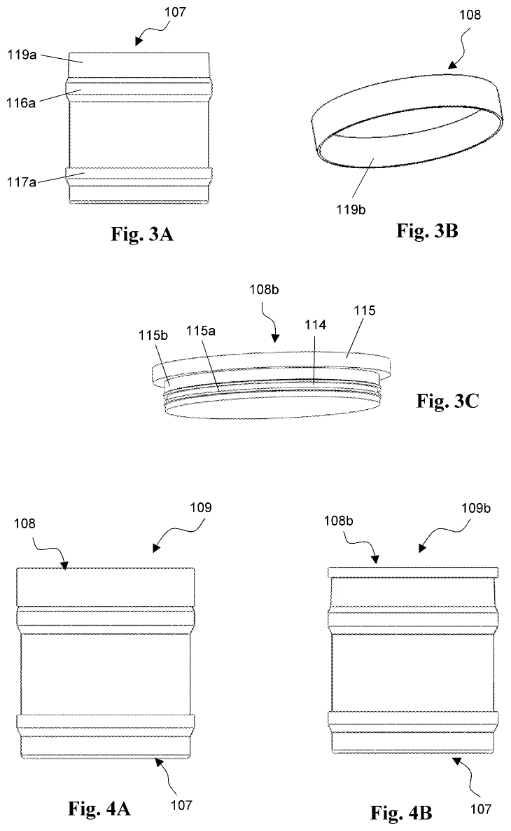

Referring to FIG. 3A, an ingredient container 107 comprises ring-shaped stiffeners 116a and 117a. The exterior surface of the ingredient container 107 comprises a partial conical surface 119a, some (partial) cylindrical surfaces, etc. The interior surface of the ingredient container 107 comprises a cylindrical surface and a flat bottom surface, and the axis of the cylindrical surface is referred to as the ‘axis of the ingredient container’ 107. The aperture of the partial conical surface 119a is configured to be relatively small, and not to exceed 12 degrees (although the limit of 12 degrees is not a strict requirement). The ingredient container 107 is configured to contain food ingredients. The ingredient container 107 further comprises a quick response (QR) code or barcode (not shown in figure) printed on the bottom surface, at the center, wherein the bottom surface is partially flat. The QR code or barcode of each ingredient container 107 is unique to that container. The QR code or barcode of an ingredient container 107 can be decoded using a device such as a camera or a scanner.

It should be noted that the partial conical surface 119a of the ingredient container 107 is a rotationally symmetric surface in the sense that the surface is invariant under any rotation around the axis of the cone which contains the partial conical surface 119a. The axis of the cone is referred to as ‘the axis of the rotationally symmetric surface.

Referring to FIG. 3B, a cap 108 comprises an internal surface 119b of a partial conical surface which is configured to be geometrically similar as the partial conical surface 119a of the ingredient container 107. The exterior surface of the cap 108 is configured to be a part of a cylindrical surface, and the axis of the cylindrical surface is referred to as ‘the axis of the cap 108.’ The cap 108 also comprise a QR code or barcode (not shown in figure) printed on the top surface which is flat. The QR code or barcode of each cap 108 is unique to each cap. The QR code or barcode of a cap 108 can be decoded using a scanner, wherein said scanner may comprise a camera configured to take a digital image of the code.

Referring to FIG. 3C, a lid 108b is a solid comprising: a flat circular part 115 as a top part; a ring-shaped exterior 115b comprising a circular groove 115a; and a rubber (or silicone gel) ring 114 which is wrapped around the circular groove 115a. The axis of the flat circular part 115 is referred to as ‘the axis of the lid 108b’. The lid 108b also comprise a QR code or barcode (not shown in figure) printed on the top surface (of the top part 115). The QR code or barcode of each lid 108b is unique to each lid and can be decoded using a scanner.

Referring to FIG. 4A, a closed ingredient container 109 comprises an ingredient container 107 and a cap 108 configured to cap on the ingredient container 107 when the surface 119b of the cap 108 touches and presses on the surface 119a of the ingredient container 107. The axis of the cap 108 is configured to coincide with the axis of the ingredient container 107. The partial conical surface 119b is configured to touch the partial conical surface 119a so that the air flow between the interior of the ingredient container 107 and the outside is restricted. Thus, the ingredient container 107 can be closed by the cap 108 so as to seal the interior of the ingredient container 107, wherein the interior may contain food ingredients. The aperture of the partial conical surface 119b may be configured to be the same or nearly the same as the aperture of the partial conical surface 119a. (The aperture of a part of a conical surface refers to the aperture of the conical surface.) The axis of the ingredient container 107 is also referred to as ‘the axis of the closed ingredient container’ 109. Due to the pressure of the surface 119b on the surface 119a in the closed ingredient container 109, the cap 108 caps on the ingredient container 107 tightly, and a force is needed to remove the cap 108 from the ingredient container 107 of the closed ingredient container 109. The cap 108 functions as a lid on the ingredient container 107. It can be used to limit or forbid air flow between the inside of ingredient container and the outside so food ingredients contained in the ingredient container can be kept fresh.

Referring to FIG. 4B, a closed ingredient container 109b comprises an ingredient container 107 and a lid 108b configured to close on the ingredient container 107. The axis of the lid 108b is configured to coincide with the axis of the ingredient container 107. The rubber (or silicone gel) ring 114 is configured to touch and press on the interior cylindrical surface of the ingredient container 107 so that the air flow between the interior of the ingredient container 107 and the outside is restricted or otherwise limited. Thus, the ingredient container 107 can be closed by the lid 108b so as to seal the interior of the ingredient container 107, wherein the interior may contain food ingredients. The axis of the ingredient container 107 is also referred to as ‘the axis of the closed ingredient container’ 109b. Due to the pressure of the rubber (or silicone gel) ring 114 on the interior cylindrical surface of the ingredient container 107 in the closed ingredient container 109b, the lid 108b can close the ingredient container 107 tightly, and a force is needed to remove the lid 108b from the ingredient container 107 of the closed ingredient container 109b. The lid 108b may be used to limit or forbid air flow between the inside of ingredient container and the outside so food ingredients contained in the ingredient container can be kept fresh.

It should be noted the cap 108 (or the lid 108b) can be removed from the ingredient container 107 by moving the cap or lid linearly away from the ingredient container 107, in the linear direction which is parallel to the axis of the ingredient container 107. An ingredient container 107 can be closed by a cap 108 (or a lid 108b) by moving the cap or lid linearly towards the ingredient container 107, in the linear direction which is parallel to the axis of the ingredient container 107.

The interior surfaces of the ingredient containers 107 discussed above may have a textured or rugged surface. The ingredient containers 107 may be made from metal, plastics for example polycarbonate (PC), polypropylene (PP), and Teflon, etc., or other solid material. The interior surfaces of the ingredient container 107 may be coated with polytetrafluoroethylene or other non-stick coating.

At times, an ingredient container may be referred to as a container; and a closed ingredient container may be referred to as a “closed container.” An ingredient container without a lid may also be referred to as an “open ingredient container,” or an “open container.”

It should be noted that there are many other ways to configure an ingredient container. An ingredient container can be any container which can contain or hold a food or food ingredient. Same applies to a lid for an ingredient container. For example, an ingredient container and a lid may comprise helical or other threads.

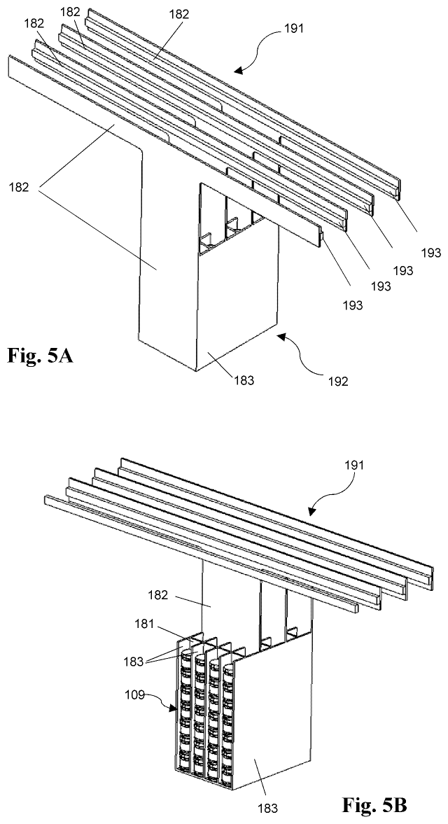

Referring to FIGS. 5A-5B, a storage apparatus 191 comprises a storage box 192 comprising a plurality of compartments arranged in a square grid, wherein each compartment is configured to store a plurality of closed containers 109 (or 109b) wherein the closed containers 109 (or 109b) are stacked vertically in the compartment. The sectional shape of each compartment is a square shape. In addition, the inside of each compartment has the shape of a square cylinder. The storage box 192 comprises vertical walls 181, 182, and 183, wherein the walls 183 are parallel to each other, and each wall 181 or 182 is perpendicular to the walls 183. The storage box 192 can be small or large.

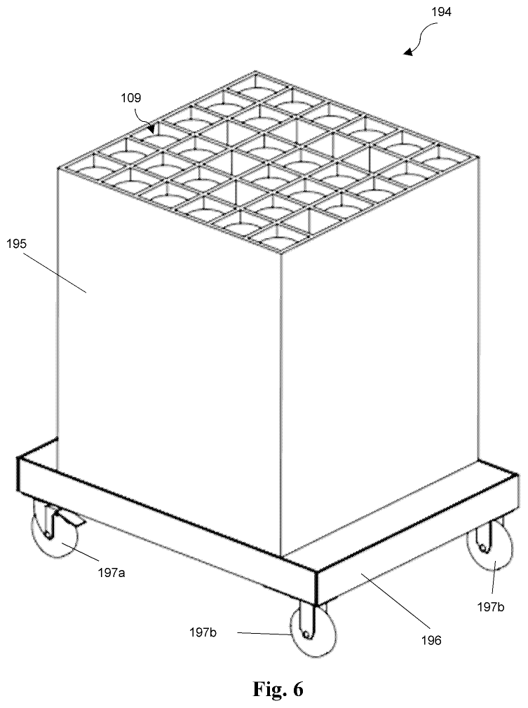

Referring to FIG. 6, a transport cart 194 comprises a transport box 195 comprising a plurality of compartments arranged in a square grid, wherein each compartment is configured to store a plurality of closed containers 109 (or 109b) where the closed containers 109 (or 109b) are stacked vertically in the compartment. The sectional shape of each compartment is a square. In addition, the inside of each compartment has the shape of a square cylinder. The transport cart 194 further comprises: a support member 196; two wheels 197b which are rotatable relative to the support member 196 around a same axis which is relatively fixed with respect to the support member 196; and two universal wheels 197a which are rotatable around an axis wherein said axis is itself rotatable relative to the support member 196. The transport cart 194 may be moved on the ground

It should also be noted that the storage box 192 may be assembled from flat boards of a material, including but not limited to metal or plastic. The transport box 195 may be assembled from flat hollow boards of a material, including but not limited to metal or plastic. A wall in the storage box 192 may be substituted by other shapes. In fact, a storage space may be divided into storage compartments by a plurality of bars (or, aluminum profiles, or a linear shape, etc.) instead of plurality of walls.

It should be noted that the compartments of the storage box 192 may be arranged in other types of grid (e.g., hexagonal grid). It is not a requirement for the grid to be regular. Same applies to the transport box. It is also possible to have compartments of mixed sizes. The sectional shape of a compartment in such a storage apparatus may alternatively be other polygon, a circle, etc., instead of a square.

The storage box 192 may be substituted by other type of storage, such as: a storage comprising horizontal compartments; a plurality of horizontal boards at different heights; a plurality of container holders each of which comprises a solid shape to position an ingredient container; etc. A storage may optionally be movable.

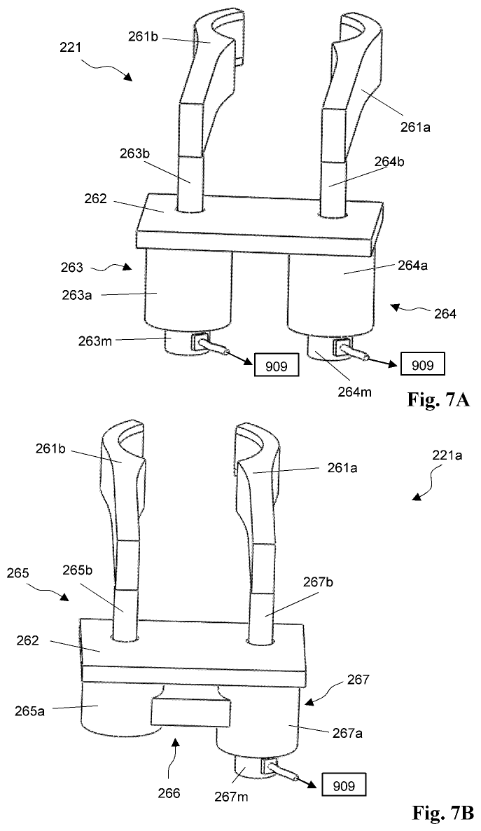

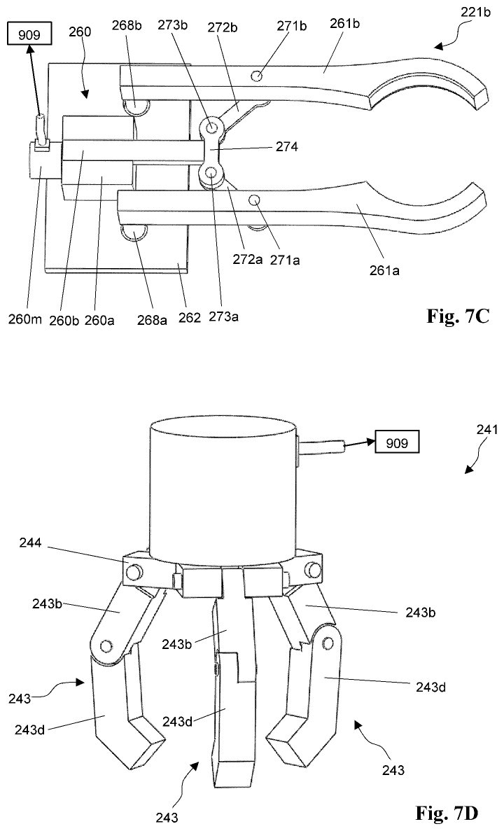

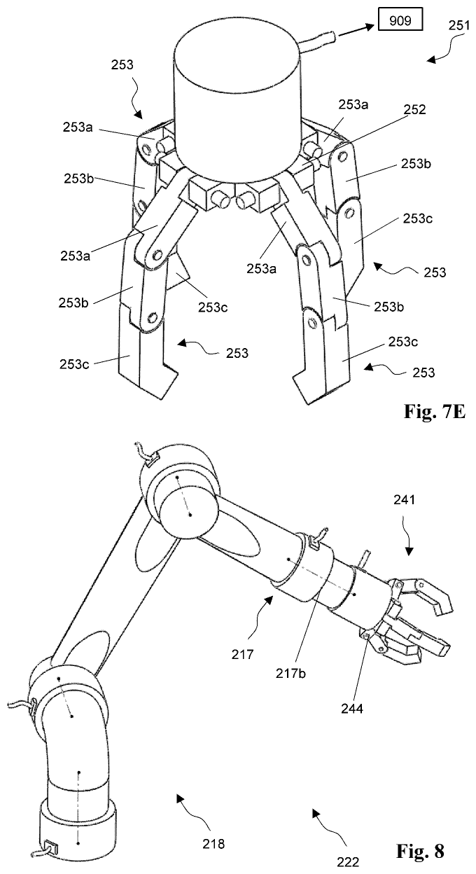

Referring to FIG. 7A, a gripper mechanism 221 comprises: grippers 261a and 261b which can optionally be rigid or elastic components; rotational motion mechanisms 263 and 264. The rotational motion mechanism 263 comprises a stationary member 263a and a moving member 263b; and the rotational motion mechanism 263 is configured to produce a rotation of the moving member 263b relative to the stationary member 263a. The rotational motion mechanism 264 comprises a stationary member 264a and a moving member 264b; and the rotational motion mechanism 264 is configured to produce a rotation of the moving member 264b relative to the stationary member 264a. The stationary members 263a and 264a are fixedly connected to a support component 262. The gripper 261a is rigidly or fixedly connected to the moving member 264b. The rotational motion mechanism 264 can produce a rotation of the gripper 261a around the axis of the rotational motion mechanism 264 relative to the stationary member 264a. Similarly, the gripper 261b is rigidly or fixedly connected to the moving member 263b. The rotational motion mechanism 263 can produce a rotation of the gripper 261b around the axis of the rotational motion mechanism 263 relative to the stationary member 263a. As the gripper 261a or 261b is rigidly connected to the moving member 264b or respectively 263b, the rotational motion mechanism 264 or 263 can produce a rotation of the gripper 261a or respectively 261b. The axis of rotation of the rotational motion mechanism 264 is parallel to the axis of rotation of the rotational motion mechanism 263, and the rotational motion mechanisms 264 and 263 are configured to rotate the respective grippers 261a and 261b in opposite directions simultaneously. Thus, the grippers 261a and 261b can be rotated anti-synchronously around a pair of parallel axes. Each of the grippers 261a and 261b is rotated between a first end-position and a second end-position. At the first end-positions, the grippers 261a and 261b may together grip a container or other object. At the second end-positions, the grippers 261a and 261b can open up and release the container or object. The motion mechanisms 263 or 264 is driven by a motor 263m or respectively 264m, which is connected to the computer system 909 by wires or by wireless means. The gripper mechanism 221 may be connected to the computer system 909 in the sense that the motors 263m and 264m are connected to the computer system 909 via wires or by wireless means, and the computer system 909 may be configured to control the motions of the grippers 261a and 261b produced by the motion mechanisms 263 and 264. Thus, the gripper mechanism 221 may be controlled by the computer system 909 to grip or loosen a container or other object.

Referring to FIG. 7B, a gripper mechanism 221a comprises: grippers 261a and 261b which are optionally rigid or elastic components; a rotational motion mechanism 267 comprising a stationary member 267a and a moving member (a shaft) 267b; a rotational mechanism 265 comprising a first mating part 265a and a second mating part (a shaft) 265b which is constrained to rotate relative to the first mating part 265a. The rotational motion mechanism 267 is configured to produce a rotational motion of the moving member 267b relative to the stationary member 267b. The stationary members 267a and the first mating part 265a are rigidly or fixedly connected to a support component 262. The gripper 261a is rigidly or fixedly connected to the moving member 267b. The gripper 261b is rigidly or fixedly connected to the second mating part (a shaft) 265b. The axis of rotation of the rotational motion mechanism 267 and the axis of the rotational mechanism 265 are configured to be parallel to each other. A transmission mechanism 266 is configured to connect the rotational motion mechanism 267 and the rotational mechanism 265, so that a rotation of the shaft 265b relative to the stationary member 267a is transmitted to an anti-synchronous rotation of the shaft 267b. Thus, the grippers 261a and 261b can be rotated anti-synchronously around a pair of parallel axes. Each of the grippers 261a and 261b is rotated between a first end-position and a second end-position. At the first end-positions, the grippers 261a and 261b may together grip a container or other object. At the second end-positions, the grippers 261a and 261b can open up and release the container or object. The motion mechanism 267 is driven by a motor 267m, which is connected to the computer system 909 via wires or by wireless means. The gripper mechanism 221a may be connected to the computer system 909 in the sense that the motor 267m is connected to the computer system 909 via wires or by wireless means, and the computer system 909 may be configured to control the motions of the grippers 261a and 261b produced by the motion mechanism 267. Thus, the gripper mechanism 221a may be controlled by the computer system 909 to grip or loosen a container or other object.

For examples of gripper mechanism 221a described above, see FIGS. 39A-39B (“gripping mechanism 701”), or FIGS. 47A-47C (“gripping mechanism 905”), of U.S. patent application Ser. No. 16/517,705. Entire content of the U.S. patent application is hereby incorporated herein by reference.

Referring to FIG. 7C, a gripper mechanism 221b comprises: a support component 262 which is a rigid component; gripping devices (also referred to as grippers) 261a and 261b; a linear motion mechanism 260; a rigid component 274; shafts 273a and 273b; links 272a and 272b; shafts 271a and 271b. The linear motion mechanism 260 comprises a stationary member 260a and a moving member 260b which is configured to move linearly (along a horizontal direction) relative to the stationary member 260a. A pair of shafts 268a and 268b are constrained to rotate relative to the support component 262 respectively around a pair of vertical axes. The shaft 273a (or respectively 273b) is configured to connect the link 272a (or respectively 272b) to the rigid component 274 so that the link 272a (or respectively 272b) is constrained to rotate relative to the rigid component 274 around the axis of the shaft 273a (or respectively 273b). The shaft 271a, 273a (or 271b) is configured to connect the link 272a (or respectively 272b) to the gripper 261a (or respectively 261b) so that the gripper 261a (or respectively 261b) is rotatable relative to the link 272a (or respectively 272b). The gripper 261a (or 261b) is rigidly or fixedly connected to the shaft 269b (or respectively 268b). Thus, the gripper 261a (or respectively 311b) is constrained to rotate relative to the support component 262 around the axis of the shaft 268a (or respectively 268b). The parts 268a, 271a, 272a, and 271a are mirror images of the parts 268b, 271b, 272b, and 271b about a vertical plane which is parallel to the direction of the linear motion of the moving member 260b relative to the stationary member 260a; wherein said stationary member 260a is rigidly or fixedly connected to the support component 262. The rigid component 274 is rigidly or fixedly connected to the moving member 260b. Thus, the linear motion mechanism 260 may produce a horizontal motion of the rigid component 274 and hence anti-synchronous rotations in the grippers 261a and 261b. Each of the grippers 261a and 261b is rotated between a first end-position and a second end-position. At the first end-positions, the grippers 261a and 261b may together grip a container or other object. At the second end-positions, the grippers 261a and 261b can open up and release the container or object. The motion mechanism 260 is driven by a motor 260m, which is connected to the computer system 909 via wires or by wireless means. The gripper mechanism 221b may be connected to the computer system 909 in the sense that the motor 260m is connected to the computer system 909 via wires or by wireless means, and the computer system 909 may be configured to control the motions of the grippers 261a and 261b produced by the motion mechanism 260. Thus, the gripper mechanism 221b may be controlled by the computer system 909 to grip or loosen a container or other object.

A gripper mechanism may also be referred to as a gripping mechanism.

Referring to FIG. 7D, a gripper mechanism 241 comprises a support component (or base component) 244 and a plurality of gripper sub-mechanisms 243 which are referred to as robotic fingers. Each gripper sub-mechanism 243 comprises: grippers 243d and 243b wherein the gripper 243d is rotatable relative to the gripper 243b and the gripper 243b is rotatable relative to the support component 244; a motion mechanism comprising a motor (hidden in Figure) which drives a rotation of the gripper 243d relative to the gripper 243b; a motion mechanism comprising a motor (hidden in figure) which drives a rotation of the gripper 243b relative to the support component 244. (It should be noted that an optional transmission mechanism may be used to link the rotation of the grippers 243d and 243b and then only one motor is needed to drive the rotations of both grippers). The gripper mechanism 241 may be connected to the computer system 909 in the sense that all motors are connected to the computer system 909 via wires or by wireless means, and the computer system 909 may be configured to control the motions produced by the motors in the gripper mechanism 241. The gripper mechanism 241 may be controlled by the computer system 909 to grip or loosen a container or other object.

Referring to FIG. 7E, a gripper mechanism 251 comprises: a support component (or base component) 252 and a plurality of gripper sub-mechanisms 253 which are referred to as robotic fingers. Each gripper sub-mechanism 253 comprises: grippers 253a, 253b and 253c, wherein the gripper 253c is rotatable relative to the gripper 253b, the gripper 253b is rotatable relative to the gripper 253a, and the gripper 253a is rotatable relative to the support component 252; a motion mechanism comprising a motor (hidden in Figure) which drives a rotation of the gripper 253c relative to the gripper 253b; a motion mechanism comprising a motor (hidden in Figure) which drives a rotation of the gripper 253b relative to the gripper 253a; a motion mechanism comprising a motor (hidden in figure) which drives a rotation of the gripper 253a relative to the support component 252. (It should be noted that an optional transmission mechanism may be used to link the rotation of the grippers 253a, 253b and 253c and then only one motor is needed to drive the rotations of both grippers). The gripper mechanism 251 may be connected to the computer system 909 in the sense that all motors are connected to the computer system 909 via wires or by wireless means, and the computer system 909 may be configured to control the motions produced by the motors in the gripper mechanism 251. The gripper mechanism 251 may be controlled by the computer system 909 to grip or loosen a container or other object.

The gripper mechanisms 241 (FIG. 7D) and 251 (FIG. 7E) are commonly referred to as robot hands. The gripper sub-mechanisms 243 and 253 are referred to as robot fingers. In fact, any robot hand may be used as a gripper mechanism for our purposes here. Robot hands may also be referred to as robot end effectors. Similarly, any robot arm may be used as a motion mechanism for our purpose.

Referring to FIG. 8, a transfer apparatus 222 comprises a robot arm 218 and a gripper mechanism 241. The gripper mechanism 241 is configured to grip or loosen a container or other object. The support component 244 of the gripper mechanism 241 is fixedly connected to the moving member 217b of the rotational motion mechanism 217 of the robot arm 218, so the robot arm can move the gripper mechanism 241. When the gripper mechanism 241 grips a container or other object, the transfer apparatus 222 can transfer the container or object to another position. The robot arm 218 and the gripper mechanism 241 may be connected to the computer system 909 via wires or by wireless means, and the computer system 909 may be configured to control the motions produced the motion mechanism in the transfer apparatus 222. The transfer apparatus 222 may be controlled by the computer system 909 to grip a container or other object, and then move the container or object, and then release the container or object at a different position

It should be noted that the gripper mechanism 221 of the transfer apparatus 222 may be substituted by the gripper mechanism 221a (or 221b) or other gripper mechanism.

It should be noted that the gripper mechanisms 221, 221a, 221b, 241 and 251 are some realizations of gripper mechanisms. They may be substituted by other types of gripper mechanism such as electric gripper, pneumatic gripper, etc.

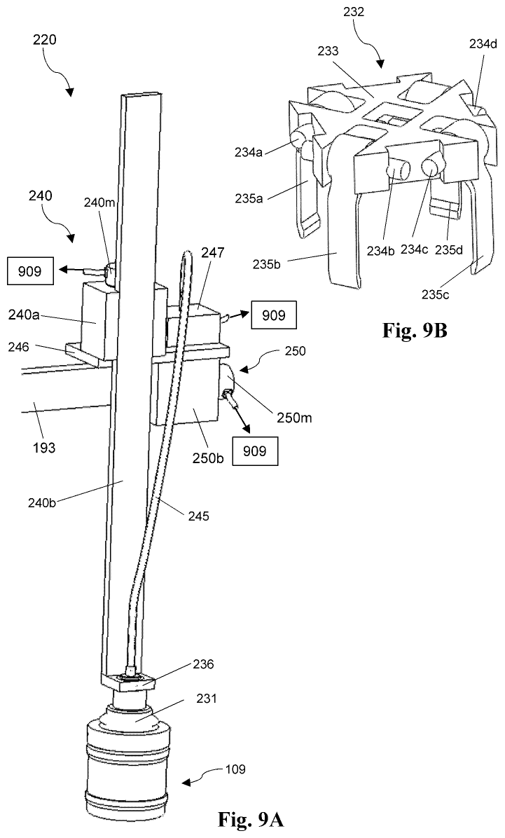

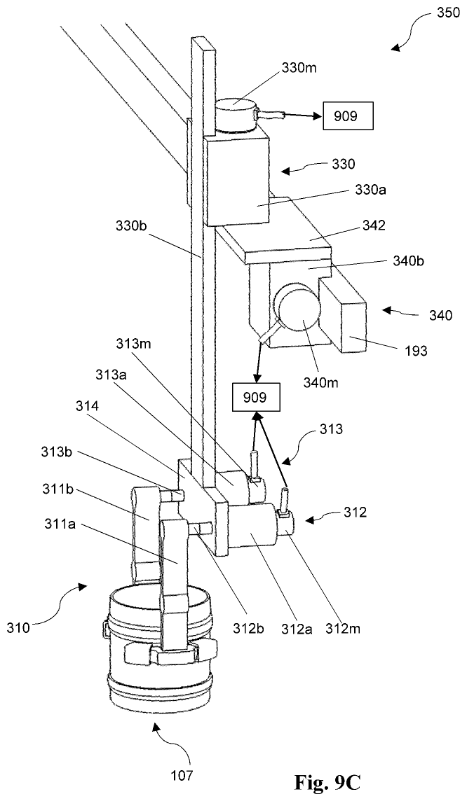

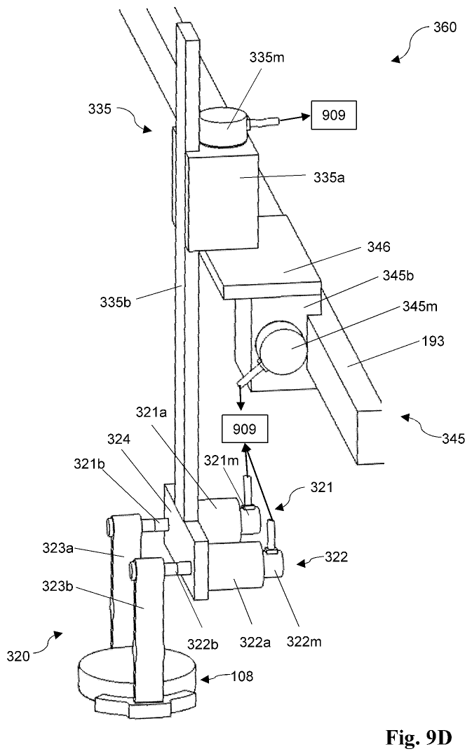

Referring to FIG. 9A, a container transfer apparatus 220 comprises a gripper mechanism which comprises a vacuum chuck 231 and a vacuum generator 247 connected to the vacuum chuck by an air pipe 245. The vacuum check 231 may grip a cap 108 (or a lid 108b) of a closed container 109 (or 109b) when a lower surface of the vacuum chuck 231 attracts a top surface of the cap 108 (or lid 108b) when the vacuum generator 247 sucks out the air in between the two surfaces. The axis of the vacuum chuck 231 may be positioned to be concentric (or nearly concentric) with the axis of the closed container 109 (or 109b) during the sucking process. The vacuum generator 247 is connected to the computer system 909 via wires or by wireless means, and the computer system 909 may be configured to control the vacuum chuck 231 to grip or loosen a closed container 109. The container transfer apparatus 220 further comprises a vertical motion mechanism 240 comprising a stationary member 240a and a moving member 240b which is configured to be moved vertically and linearly relative to the stationary member 240a. The vacuum chuck 231 is mounted on the moving member 240b of the vertical motion mechanism 240 via a connector 236. The vertical motion mechanism 240 can produce a vertical linear motion of the moving member 240b and hence of the vacuum chuck 231 relative to the stationary member 240a. The container transfer apparatus 220 further comprises a horizontal motion mechanism 250 comprising a stationary member 193 and a moving member 250b which is configured to be moved horizontally and linearly relative to the stationary member 193. The stationary member 193 is fixedly or rigidly connected to the extension of a wall 182 of the storage box 192 (as shown in FIG. 5A). The moving member 250b is rigidly or fixedly connected to the stationary member 240a of the vertical motion mechanism 240 via a connector 246. The horizontal motion mechanism 250 can produce a horizontal linear motion of the moving member 250b (hence of the stationary member 240a) relative to the stationary member 193. The container transfer apparatus 220 can move a closed container 109 (or 109b) in the vertical direction and then in the horizontal direction. When the container transfer apparatus 220 is properly positioned relatively to the storage box 192 or transport box 195 of a transport cart 194, the vacuum chuck 231 can be moved to a position inside a square compartment of said box. At that position, the vacuum chuck 231 may suck and grip a closed container 109 (or 109b) therein. Then, the container transfer apparatus 220 may lift the closed container 109 (or 109b) together with the vacuum chuck 231 and the moving member 240b upward. Then, the container transfer apparatus 220 can move with the gripped closed container 109 (or 109b) to another position where the vacuum chuck 231 together with the moving member 240b can be moved downward and then release the closed container. The motion mechanism 240 or respectively 250 is driven by a motor 240m or respectively 250m, which is connected to the computer system 909 via wires or by wireless means. The container transfer apparatus 220 may be connected to the computer system 909 in the sense that the motors and the vacuum generator are connected to the computer system 909, and the computer system 909 may be configured to control the motions produced by the motors and the vacuum generator of the container transfer apparatus 220. The container transfer apparatus 220 may be controlled by the computer system 909 to grip a closed container 109 (or 109b), and then move the closed container vertically, and then horizontally, and then release the closed container 109 (or 109b) at a different position.

The vacuum chuck 231 is also an example of gripper.

A gripper mechanism may comprise a vacuum chuck and a vacuum generator connected to the vacuum chuck by air pipes. A computer may control the gripper mechanism by controlling the vacuum generator.

Referring to FIG. 9B, a gripper mechanism 232 comprises: a rigid component 233; gripping devices (also referred to as grippers) 235a, 235b, 235c and 235d; shafts 234a, 234b, 235c and 235d. The axes of the shafts are all horizontal. The shaft 234a, 234b, 235c, or 235d is either constrained to rotate relative to the rigid component 233 around the axis of the respective shaft, or rigidly or fixedly connected to the rigid component 233. The grippers 235a, 235b, 235c and 235d are respectively connected to the shafts 234a, 234b, 235c and 235d, so that each gripper is constrained to rotate relative to the rigid component 233 around the axis of the respective shaft. One or more motors are configured to drive the rotations of the grippers 235a, 235b, 235c and 235d so that the grippers may rotate simultaneously toward (or away) a central vertical axis as to grip (or respectively, release) a closed container 109 whose axis coincides with said central vertical axis; wherein said central vertical axis is referred to as the central axis of the gripper mechanism 232. All motors of the gripper mechanism 232 may be connected to the computer system 909 via wires or by wireless means, and the computer system 909 may be configured to control the gripper mechanism 232 to grip or loosen a closed container 109. The grippers may optionally be positioned symmetrically on 4 corners of a square. The gripping mechanism 232 may optionally be symmetric under a rotation of 90 degrees.

It should be noted that the gripper mechanism comprising the vacuum chuck 231 of the container transfer apparatus 220 may be substituted by the gripper mechanism 232 (of FIG. 9B) or other gripper mechanism. More details are found in U.S. patent application Ser. No. 15/798,357. Entire contents of the application are hereby incorporated herein by reference.

Referring to FIG. 9C, a container transfer apparatus 350 comprises a container gripper mechanism 310 comprising: gripping devices (also referred to as grippers) 311a and 311b; rotational motion mechanisms 312 and 313. The rotational motion mechanism 312 comprises a stationary member 312a and a moving member 312b. The rotational motion mechanism 313 comprises a stationary member 313a and a moving member 313b. The stationary members 313a and 312a are rigidly or fixedly connected to a support component 314. The gripping device 311a is rigidly or fixedly connected to the moving member 312b. The rotational motion mechanism 312 can produce a rotation of the gripping device 311a around the axis of the rotational motion mechanism 312 relative to the stationary member 312a. Similarly, the gripping device 311b is rigidly connected to the moving member 313b. The rotational motion mechanism 313 can produce a rotation of the gripping device 311b around the axis of the rotational motion mechanism 313 relative to the stationary component 313a. The axis of rotation of the rotational motion mechanism 312 is parallel to the axis of rotation of the rotational motion mechanism 313. The gripping devices 311a and 311b can be rotated anti-synchronously around a pair of parallel axes. Each of the gripping devices 311a and 311b is rotated between a first end-position and a second end-position. At the first end-positions, the gripping devices 311a and 311b may together grip a container 107. At the second end-positions, the gripping devices 311a and 331b can open up and release the container 107.

The container transfer apparatus 350 further comprises a vertical motion mechanism 330 and a horizontal motion mechanism 340. Said vertical motion mechanism 330 comprises a stationary member 330a and a moving member 330b which is configured to be moved vertically and linearly relative to the stationary member 330a. The moving member 330b is rigidly connected to the support component 314 of the container gripper mechanism 310. The vertical motion mechanism 330 can produce a vertical linear motion of the moving member 330b and hence of the support component 314 relative to the stationary member 330a. Said horizontal motion mechanism 340 comprises a stationary member 193 and a moving member 340b which is configured to be moved horizontally and linearly relative to the stationary member 193. In our applications, the stationary member 193 is rigidly or fixedly connected to the extension of a wall 182 of the storage box 192 and positioned along a horizontal direction (wherein the storage box 192 is shown in FIG. 5A). The moving member 340b of the horizontal motion mechanism 340 is fixedly connected to the stationary member 330a of the vertical motion mechanism 330 via a connector 342. The horizontal motion mechanism 340 can produce a horizontal linear motion of the moving member 340b and hence of the stationary member 330a relative to the stationary member 193. The motion mechanism 330, 340, 312 or 313 is driven by a motor 330m, 340m, 312m or respectively 313m, which is connected to the computer system 909 via wires or by wireless means, and the computer system 909 may be configured to control the motions produced by the motion mechanisms of the container transfer apparatus 350. The container transfer apparatus 350 may be controlled by the computer system 909 to grip a container 107, and then move the container vertically, and then horizontally, and then release the container 107 at a different position.

Referring to FIG. 9D, a lid opening sub-apparatus 360 comprises a lid gripper mechanism 320 comprising: gripping devices (also referred to as grippers) 323a and 323b; rotational motion mechanisms 321 and 322. The rotational motion mechanism 321 comprises a stationary member 321a and a moving member 321b. The rotational motion mechanism 322 comprises a stationary member 322a and a moving member 322b. The stationary members 321a and 322a are fixedly or fixedly connected to a support component 324. The gripping device 323a is rigidly or fixedly connected to the moving member 321b. The rotational motion mechanism 321 can produce a rotation of the gripping device 323a around the axis of the rotational motion mechanism 321 relative to the stationary member 321a. Similarly, the gripping device 323b is rigidly or fixedly connected to the moving member 322b. The rotational motion mechanism 322 can produce a rotation of the gripping device 323b around the axis of the rotational motion mechanism 322 relative to the stationary member 322a. As the gripping device 323a or 323b is rigidly connected to the moving member 321b or respectively 322b, the rotational motion mechanism 321 or 322 can produce a rotation of the gripping device 323a or respectively 323b. The axis of rotation of the rotational motion mechanism 321 is parallel to the axis of rotation of the rotational motion mechanism 322, and the rotational motion mechanisms 321 and 322 are configured to rotate the gripping devices 323a and 323b anti-synchronously around a pair of parallel axes. Each of the gripping devices 323a and 323b is rotated between a first end-position and a second end-position. At the first end-positions, the gripping devices 323a and 323b may together grip a cap 108 (or a lid 108b) of a closed container 109 (or 109b). At the second end-positions, the gripping devices 323a and 323b can open up and release the cap 108 (or a lid 108b).

The lid opening sub-apparatus 360 further comprises a vertical motion mechanism 335 and a horizontal motion mechanism 345. Said vertical motion mechanism 335 comprises a stationary member 335a and a moving member 335b which is configured to be moved vertically and linearly relative to the stationary member 335a. The moving member 335b is fixedly connected to the support component 324 of the lid gripper mechanism 320. The vertical motion mechanism 335 can produce a vertical linear motion of the moving member 335b and of the support component 324 relative to the stationary member 335a. Said horizontal motion mechanism 345 comprises a stationary member 193 and a moving member 345b which is configured to be moved horizontally and linearly relative to the stationary member 193. The stationary member 193 is fixedly connected to the extension of a wall 182 of the storage box 192 and positioned along a horizontal direction (shown in FIG. 5A). The moving member 345b of the horizontal motion mechanism 340 is fixedly connected to the stationary member 335a of the vertical motion mechanism 335 via a connector 346. The horizontal motion mechanism 345 can produce a horizontal linear motion of the moving member 345b and hence of the stationary member 335a relative to the stationary member 193. The motion mechanism 335, 345, 321 or 322 is driven by a motor 335m, 345m, 321m, or respectively 322m, which is connected to the computer system 909 via wires or by wireless means, and the computer system 909 may be configured to control the motions produced by the motion mechanisms of the lid opening sub-apparatus 360. The lid opening sub-apparatus 360 may be controlled by the computer system 909 to grip a cap 108 (or a lid 108b), and remove the cap 108 (or the lid 108b) from the container 107 when the cap is moved upward with the moving member 335b and when the container 107 is (gripped by another gripper mechanism and) not moved. Then the cap (or lid) may be moved horizontally and linearly together with the lid gripper mechanism 320. Then the lid gripper mechanism 320 may release the cap 108 (or the lid 108b) at a different position.

It should be noted that the structures of the gripper mechanism 320 and the gripper mechanism 310 are similar to the gripper mechanism 221. The gripper mechanism 310 or the gripper mechanism 320 may be substituted by the gripper mechanism 221a (or 221b) or other gripper mechanism as to grip and let loose a container 107, or a cap 108 (or a lid 108b).

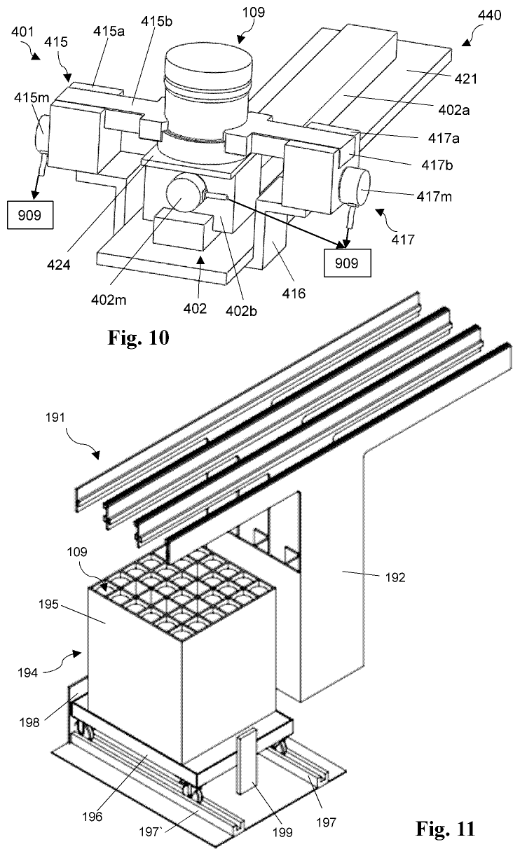

Referring to FIG. 10, a sub-apparatus 440 comprises: a container gripper mechanism 401 comprising two linear motion mechanisms 415 and 417. The linear moving mechanism 415 comprises a stationary member 415a and a moving member 415b. The moving mechanism 417 comprises a stationary member 417a and a moving member 417b. The stationary member 415a and 417a are fixedly connected to a support component 416. The linear motion mechanism 415 can produce a linear motion of the moving member 415b relative to the stationary member 415a. The linear motion mechanism 417 can produce a linear motion of the moving member 417b relative to the stationary member 417a. The moving member 415b or 417b may be referred as a gripping device or gripper. The moving members 415b and 417b may be simultaneously moved toward (or away) a vertical axis as to grip (or respectively, release) a container 107 whose axis coincides with said vertical axis; wherein said vertical axis is referred to as the central axis of the container gripper mechanism 401.

The sub-apparatus 440 further comprises a horizontal motion mechanism 402 and a container holder 424 comprising a solid shape to position or hold an ingredient container. The horizontal motion mechanism 402 comprises a stationary member 402a and a moving member 402b which is configured to be moved horizontally and linearly relative to the stationary member 402a. The container holder 424 is fixedly connected to the moving member 402b. The container holder 424 can optionally be a cup with cylinder shape comprising a vertical axis, wherein said cup may position and hold a container 107. The container holder 424 may optionally restrict the movement of the container 107 when the container holder 424 is moved. The support component 416 is fixedly connected to the stationary member 402a of the horizontal motion mechanism 402 via a connector 421. The horizontal motion mechanism 402 can produce a horizontal linear motion of the stationary member 402a and hence of the container holder 424 relative to the stationary member 402a (and the container gripper mechanism 401). The motion mechanisms 402, 415 or 417 is driven by a motor 402m, 415m or respectively 417m, which is connected to the computer system 909 via wires or by wireless means, and the computer system 909 may be configured to control the motions produced by the motion mechanisms of the sub-apparatus 440. A closed container 109 (or 109b) can be placed on the container holder 424 and can be moved to a certain position so that the container gripper mechanism 401 can grip the container 107 of the closed container 109 (or 109b).

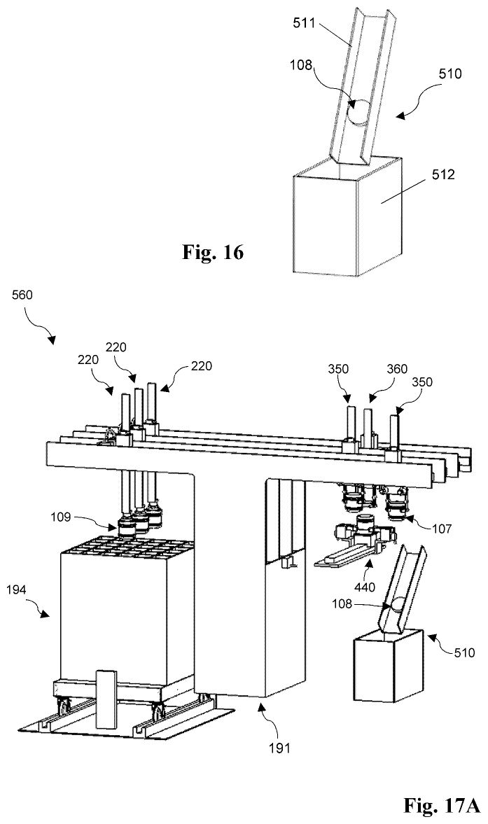

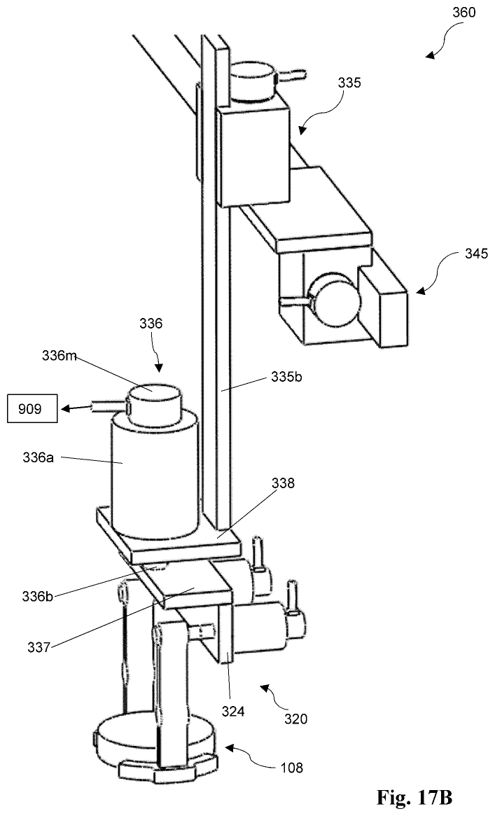

Referring to FIGS. 11-17A, a storage station 560 comprises: a storage apparatus 191 (as shown in FIG. 5A); transfer apparatuses 220 (as shown in FIG. 9A); container transfer apparatuses 350 (as shown in FIG. 9C); a lid opening apparatus comprising a sub-apparatus 440 (as shown in FIG. 10) and a lid opening sub-apparatus 360 (as shown in FIG. 9D). The storage station 560 further comprises a lid collection apparatus 510 comprising a sliding path 511 and a container 512 configured to store a plurality of lids (see FIG. 16). The container 512 can be a storage box, as shown in FIG. 16 but it can have other shapes. A cap 108 (or a lid 108b) may slide into the container 512 along the sliding path 511. The connector 421 of the sub-apparatus 440, the storage apparatus 191, and the lid collection apparatus 510 may optionally be rigidly or fixedly connected to the ground, by known techniques, so that their positions are fixed with respect to each other. As shown in FIG. 11, the storage station 560 further comprises a pair of slotted rail tracks 197, all configured to be fixedly connected to the ground. The wheels of the transport cart 194 may move on the slotted rail tracks 197. The storage station 560 further comprises a limiting device 198 which is fixedly connected to the ground and a limiting device 199 which can be removed when the transport cart needs to be moved out. When the wheels of the box are positioned on the slotted rail tracks 197, the limiting devices 198 and limiting devices 199 are used as physical barriers as to fix the position of the transport cart 194; and when the position of the transport cart is fixed by the limiting devices, that the transport box 195 of the transport cart 194 becomes parallel to the storage box 192 of the storage apparatus 191.

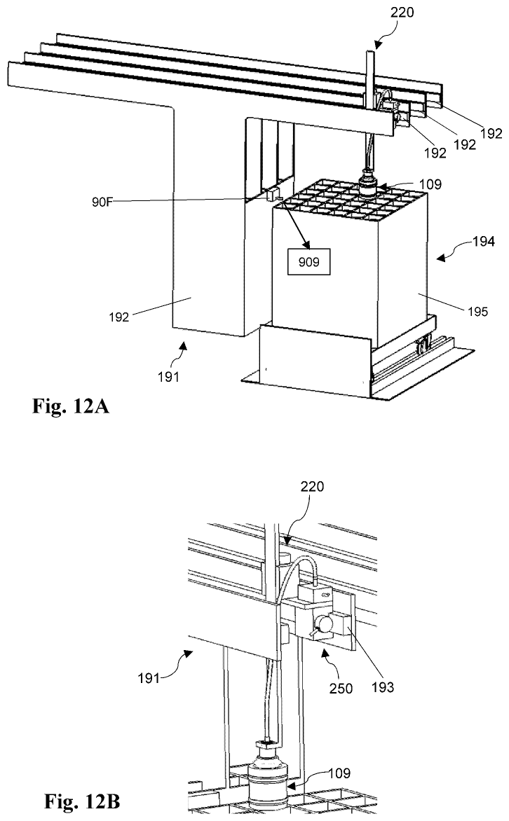

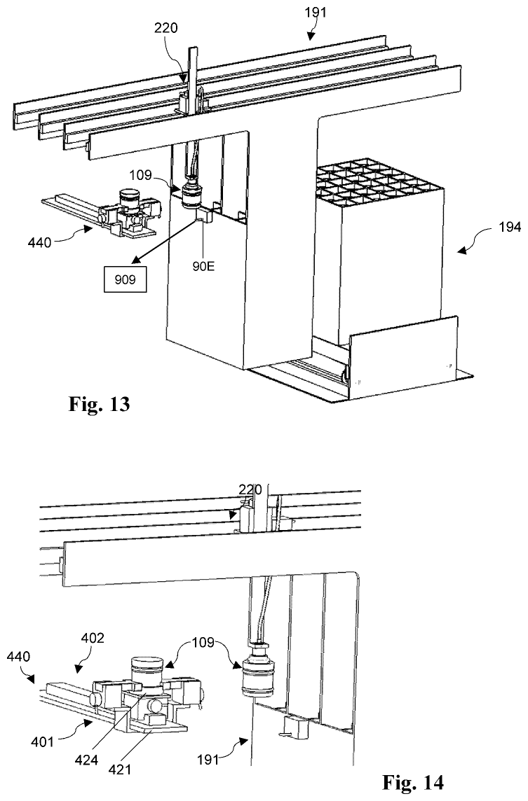

The storage station 560 further comprises scanners 90E and 90F, which are fixedly mounted on the storage apparatus 191 (see FIGS. 12A-13). The scanners 90E and 90F are connected to the computer system 909, so that the computer system 909 may receive and/or send information from and/or to the scanners 90E and 90F. When a closed container 109 (or 109b) passes through a position above the scanner 90F or 90E, the scanner 90F or 90E can capture a digital image of the QR code or barcode of the container 107, and then send the information to the computer system 909 that decodes the QR code or barcode. The QR code or barcode information of the closed container 109 (or 109b) are recorded by the computer system 909. The QR code or barcode on each container is configured to be unique to the container. The identities and the codes of the containers 107 can be recorded by the computer system 909.

It should be noted that the scanner 90E or 90F may optionally comprise a microcomputer configured to decode the QR code or barcode on a closed container 109 (or 109b). Otherwise, the computer system 909 is configured to decode the QR code or barcode.

A transport cart 194 may be positioned at a certain location in the storage apparatus 191, being restrained by the limiting devices 198 and 199. Under the control of the computer system 909, the container transfer apparatus 220 can transfer a closed container 109 (or 109b) out of the storage box 192 of the storage apparatus 191, as follows. At step 1, the vacuum chuck 231 of the container transfer apparatus 220 may be moved horizontally and linearly and then vertically down to a position as to grip a closed container 109 (or 109b) in a square compartment of the storage box 192. At step 2, the vacuum chuck 231, together with the gripped closed container 109 (or 109b), may be moved vertically up, so that the gripped closed container 109 (or 109b) is totally outside of the storage box 192. At step 3, the vacuum chuck 231, together with the gripped closed container 109 (or 109b), may be moved horizontally and linearly, and then vertically down, to a position so that the QR code or barcode on the bottom of the gripped closed container 109 (or 109b) may be read by the scanner 90E (see FIG. 13). At step 4, the vacuum chuck 231 of the container transfer apparatus 220 may be moved horizontally and linearly, and then vertically down to a position as to release the closed container 109 to the container holder 424 of the horizontal transport mechanism 402, wherein the container holder 424 needed to move to the receiving position in advance. At step 5, the vacuum chuck 231 of the container transfer apparatus 220 is moved vertically up and can be used for the next task. Similarly, the container transfer apparatus 220 may transfer a closed container 109 from one into the other among the compartments of the storage box and transport box.

As explained before, each time a closed container 109 (or 109b) is put in or taken away from the storage apparatus 191, the QR code or barcode of the closed container 109 (or 109b) is decoded by the scanner 90E or 90F. The signals of the scanners 90E and 90F are sent to the computer system 909, so that the data of the closed containers 109 (or 109b) in the storage apparatus 191 are stored and dealt by the computer system 909.

Two containers of food ingredients are said to have the same ‘container content type,’ if they contain the same types of food ingredients, and the weight of the food ingredient of each type is the same for both containers. Although this is not strictly necessary, a single compartment in the storage apparatus 191 may be configured to store containers of the same container content type.

It should also be noted that the container transfer apparatus 220 may move a closed container 109 (or 109b) from one compartment to another.

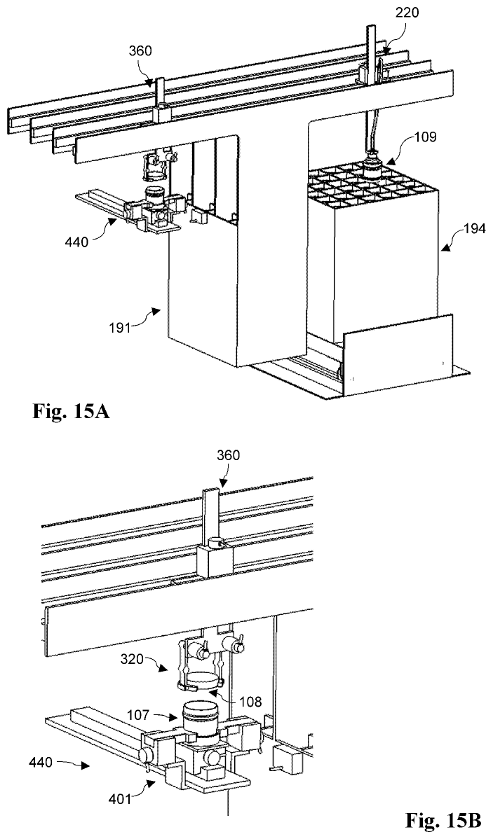

When a closed container 109 (or 109b) is placed on the container holder 424 and moved to the position so that the container 107 of the closed container 109 (or 109b) is gripped by the container gripper mechanism 401 (of the sub-apparatus 440), the lid opening sub-apparatus 360 may be used to grip the cap 108 (or the lid 108b) of the closed container 109 (or 109b) and then to move the cap 108 (or the lid 108b) vertically upward (see FIG. 15B). The cap 108 (or the lid 108b) is thus removed from the container 107. The cap 108 (or the lid 108b) may be then moved horizontally and linearly by the motion mechanism 345 of the lid opening sub-apparatus 360 and be released and unloaded to the sliding path of the lid collection apparatus 510. The above procedures involve the following detailed steps (see FIGS. 15A, 15B, 16 and 17A). At step 1, the sub-apparatus 440 may move the container holder 424 with said closed container 109 (or 109b

to a position where the axis of the closed container 109 (or 109b) coincides with the central axis of the container gripper mechanism 401 of the sub-apparatus 440. At step 2, the container gripper mechanism 401 of the sub-apparatus 440 grips the container 107 of the closed container 109 (or 109b). At step 3, the lid gripper mechanism 320 of the lid opening sub-apparatus 360 is moved horizontally and linearly and then vertically downward, and then grip the cap 108 (or the lid 108b) of said closed container 109 (or 109b). At step 4, the lid gripper mechanism 320 together with the gripped cap 108 (or the gripped lid 108b), are moved vertically upward, thus remove the cap 108 (or the lid 108b) from the container 107. At step 5, the lid gripper mechanism 320 of the lid opening sub-apparatus 360 may be moved horizontally and linearly, and then vertically down, to a position as to release the cap 108 (or the lid 108b) into the sliding path of the lid collection apparatus 510. At step 6, the lid gripper mechanism 320 is moved vertically up. Meanwhile, the container gripper mechanism 401 of the sub-apparatus 440 may release the container 107, and then the container 107 and the container holder 424 may be moved to another position as to be gripped and moved by a container transfer apparatus 350 as follows. The container gripper mechanism 310 of the container transfer apparatus 350 may be moved horizontally and linearly and then vertically down, and then may grip the container 107 placed on the container holder 424. Then the container gripper mechanism 310 together with the gripped container 107 are moved vertically upward, and then horizontally by the motion mechanism 340 (of the container transfer apparatus 350). Then, the container gripper mechanism 310 may be moved vertically down to a position as to release the container 107 to be placed on a container holder of a vehicle in the transport system (to be described later).

It should be noted that the storage apparatus 191 may be substituted by other types of storage of containers. For example, a storage apparatus may comprise horizontal compartments instead of the vertical compartments of FIGS. 5A-5B. In this case, a container transfer apparatus 220 may be substituted by a different type of transfer apparatus: the vertical linear motion mechanism 240 needs to be substituted by a horizontal linear motion mechanism.

The storage apparatus 191, the transfer apparatuses 220, the container transfer apparatuses 350, the lid opening apparatus of the storage station 560 may be substituted by the storage apparatus, transfer apparatuses, cap opening apparatus described in U.S. patent application Ser. No. 15/798,357, the disclosure of which is hereby incorporated herein by reference in its entirety.

It should be noted that the ingredient containers and the lids may comprise helical threads in which case the lid opening sub-apparatus 360 of lid opening apparatus may need to add a rotational motion mechanism 336 in addition to the vertical motion mechanism 335 (as shown in FIG. 17B). Said rotational motion mechanism 336 comprises a stationary member 336a and a moving member 336b which is configured to be rotated relative to the stationary member 330a. The stationary member 336a is fixedly or rigidly connected to the moving member 335b of the vertical motion mechanism 335 via a connector 338. The moving membe 336a is rigidly or fixedly connected to the support component 324 of the lid gripper mechanism 320 via a connector 337, so that the support component 324 of the lid gripper mechanism 320 may be moved by the combination of a vertical motion and a rotational motion, as to remove a lid from an ingredient container. The motion mechanism 336 is driven by a motor 336m, which is connected to the computer system 909 by wires or by wireless means. This is not hard to do.

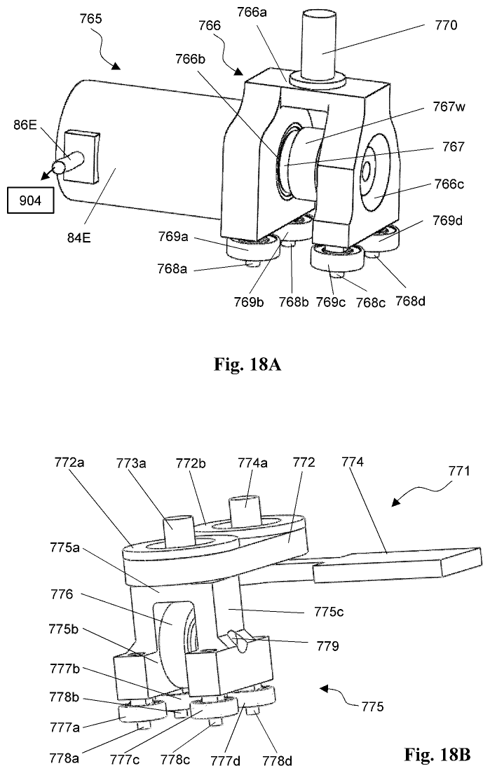

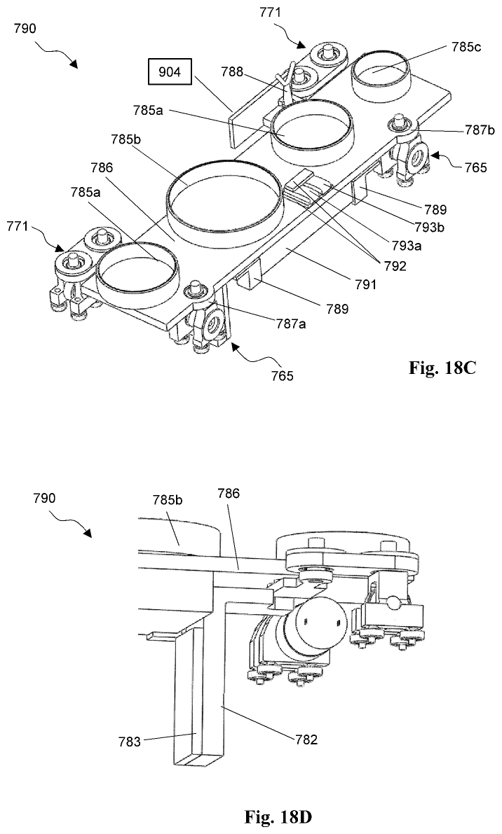

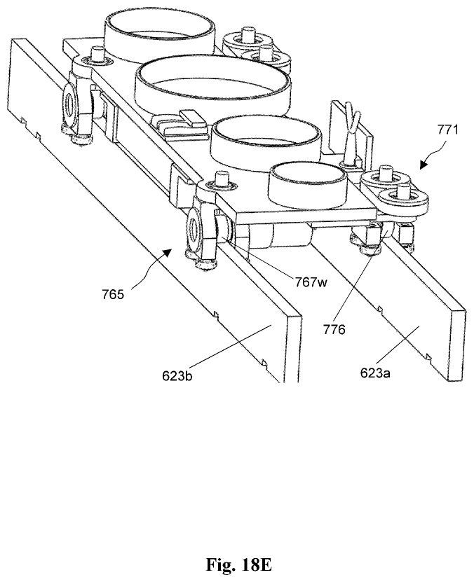

Referring to FIGS. 18A-18D, a vehicle 790 comprises: a support component 786 comprising two bearing housings 787a and 787b as parts; a computer 904 which is fixedly connected to the support component 786 by connectors; two driving wheel mechanisms 765; two universal wheel mechanisms 771. The bearing housing 787a or 787b is connected to a shaft 770 of one of the driving wheel mechanisms 765 by bearings and accessories, so that the shaft 770 is constrained to rotate relative to the support component 786 around the axis of the shaft 770. The connecting components 774 of the universal wheel mechanisms 771 are rigidly connected to the support component 786.

The computer 904 comprises a plurality of input ports and a plurality of output ports. The input ports of the computer 904 may be connected (either via wires or via wireless communication devices) to sensors, which can be encoders, pressure sensors, proximity switches, micro switches, infrared sensors, temperature sensors, etc. The output ports of the computer 904 may be connected to electrical or electronic devices which can be several types of motors, stoves, refrigeration apparatus, etc. The signals of the sensors may be sent to the computer 904. The computer 904 may control the operations of the electrical or electronic devices by sending signals to the electrical or electronic device. The computer 904 is configured to communicate with the computer system 909 via a wireless communication device 788.

Referring to FIG. 18A, a driving wheel mechanism 765 comprises: a support component 766; a shaft 767 comprising a horizontal axis; and a wheel 767w which is rigidly connected to and concentric with the shaft 767; shafts 770, 768a, 768b, 768c and 768d, each comprising a vertical axis; and wheels 769a, 769b, 769c and 769d. The support component 766 comprises a pair of bearing housings 766b and 766c which have a same horizontal axis. The shaft 770 is rigidly connected to a top part 766a of the support component 766. The shaft 767 is configured to be connected to the bearing housings 766b and 766c by bearings and accessories, so that the shaft 767 is constrained to rotate relative to the support component 766 around the axis of the shaft 767. The shafts 768a, 768b,768c and 768d are configured to be rigidly connected to (some bottom parts of) the support component 766. The wheels 769a, 769b, 769c and 769d are respectively mounted on the shafts 768a, 768b, 768c and 768d, so that each wheel is constrained to rotate relative to the support component 766 around the axis of the respective shaft.

The driving wheel mechanism 765 further comprises a motor 84E comprising a shaft and a base component. The base component of the motor 84E is fixedly connected to the bearing housing 766b. The shaft of the motor 84E is fixedly connected to the shaft 767, so that the motor 84E can drive a rotation in the shaft 767 and hence in the wheel 767w relative to the support component 766 around the axis of the shaft 767. As shown in FIG. 18A, the motor 84E is connected to a computer 904 via wires 86E, the computer 904 is configured to send signals to the motor 84E as to control the timing and the degree of rotation of the motor 84E.

Referring to FIG. 18B, a universal wheel mechanism 771 comprises: a support component 775; a connector 772 comprising two bearing housings 772a and 772b as parts; a connecting component 774 comprise a vertical shaft 774a; a shaft 779 comprising a horizontal axis; shafts 773a, 778a, 778b, 778c and 778d, each comprising a vertical axis; and wheels 776, 777a, 777b, 777c and 777d. The shaft 773a is rigidly connected to a top part 775a of the support component 775. The shaft 773a is configured to be connected to the bearing housing 772a by bearings and accessories, so that the support component 775 and the shaft 773a are constrained to rotate relative to the bearing housing 772a (or equivalently, relative to the connector 772) around the axis of the shaft 773a. The shaft 774a of the connecting component 774 is configured to be connected to the bearing housing 772b by bearings and accessories, so that the connecting component 774 is constrained to rotate relative to the bearing housing 772b (or equivalently, relative to the connector 772) around the axis of the shaft 774a. The shaft 779 is configured to be fixedly connected to the support component 775. The wheel 776 is mounted on the shaft 779, so that the wheel 776 is constrained to rotate relative to the shaft 779 (and hence relative to the support component 775) around the axis of the shaft 779. The shafts 778a, 778b,778c and 778d are configured to be rigidly connected to (some bottom parts of) the support component 775. The wheels 777a, 777b, 777c and 777d are respectively mounted on the shafts 768a, 768b, 768c and 768d, so that each wheel is constrained to rotate relative to the support component 775 around the axis of the respective shaft.

The vehicle 790 further comprises: a plurality of round holding cups 785a, 785b and 785c wherein each holding cup 785a, 785b or 785c comprises a vertical axis; a rechargeable battery 791 configured to power electrical or electronic devices on the vehicles; a plurality of mounting devices 789 configured to fixedly connect the rechargeable battery 791 to the support component 786; an insulation component 792 made of plastic or other electric insulating material; and a pair of electrical inlets 793a and 793b connected to the rechargeable battery 791 by wires. The electrical inlets 793a and 793b and the insulation component 792 are all fixedly connected to the support component 786. The holding cups 785a, 785b and 785c are fixedly connected to the support component 786. Each holding cup 785a, 785b or 785c is configured to hold an ingredient container 107 of a specific diametrical size.

The holding cups 785a, 785b and 785c are also referred to as container holders. It should be noted that any of the container holders in the vehicle 790 may be substituted by a solid shape which can position or hold an ingredient container.

The vehicle 790 further comprises: a rigid component 782 comprising a vertical part and a horizontal part; a magnet 783 configured to fixedly mounted on the vertical part of the rigid component 782. The horizontal part of the rigid component 782 is rigidly connected to the support component 786.

Each holding cup 785a on a vehicle 790 may hold an ingredient container 107 so that the movement of said ingredient container may be restricted or limited when the vehicle is moving. Similarly, each holding cup 785b on each vehicle 790 is configured to hold an ingredient container 107b (and/or other types of ingredient containers) wherein said ingredient container 107b is similarly configured as an ingredient container 107 except the size. Thus, the vehicle 790 may carry and transport a plurality of ingredient containers.

The vehicle 790 may comprise an electromagnet controlled by the computer 904. The computer 904 is configured to monitor the rechargeable battery 791. If the rechargeable battery is running low, the computer 904 is configured to turn on the electromagnet; otherwise the computer turns off the electromagnet. The electro-magnetic signal may be sensed by a sensor mounted next to a rail track, wherein said sensor is connected to the computer system 909. The computer system can then automatically control the motion of the vehicle 790 so the vehicle can arrive at a charging station, so that the rechargeable battery gets charged.

The vehicle 790 is configured to move on a pair of rail tracks 623a and 623b (see FIG. 18E). The driving wheels 767w are configured to move on and touch the top surface of the rail track 623b. The wheels 776 are configured to move on and touch the top surface of the rail track 623a. The pair of wheels 769a and 769c (or the pair of wheels 769b and 769d) of each driving wheel mechanism 765 are configured to be limited by or to touch the opposite sides of the rail track 623b. The pair of wheels 777a and 777c (or the pair of wheels 777b and 777d) of each universal wheel mechanism 771 are configured to be limited by or to touch the opposite sides of the rail track 623a. The rail tracks 623a and 623b are straight and have a fixed width.

It should be noted that the vehicle 790 may move on a pair of curved rail tracks whose widths are smaller than the widths of straight rail tracks. The vehicle 790 can carry and transport a plurality of ingredient containers. When the vehicle 790 moves, then the vehicle 790 can transport the ingredient containers held by the holding cups of the vehicle.

Referring to FIG. 19A, a device 618 comprises: two rigid components 618h and 618b; a first group of rail tracks comprising two pairs of linear rail tracks 618a and 618c, 618d and 618e; a second group of rail tracks comprising a pair of curved rail tracks 618f and 618g; a third group of rail tracks comprising a pair of curved rail tracks 618k and 618m. The rigid components 618h and 618b have the shape of vertical boards, although this is not a strict requirement. All rail tracks 618a, 618c, 618d, 618e, 618f, 618g, 618k and 618m are configured to be fixedly connected to the vertical boards 618h and 618b. The rail tracks in each group of rail tracks are configured to be coplanar. The boards and the rail tracks are configured to be rigidly connected to each other, so the device 618 may be regarded as a rigid body.

Referring to FIG. 19B, a track switch mechanism 621 comprises a rotational motion mechanism 603 and a device 618. The rotational motion mechanism 603 comprises a moving member 603b and a stationary member 603a. The vertical boards 618h and 618b of the device 618 are fixedly connected to the moving member 603b via a connector 602. The stationary member 603a is fixedly connected to a rigid component 601 which has the shape of a vertical board. The rigid component 601 may be referred to as a support component. The rotational motion mechanism 603 may produce an intermittent rotation of the moving member 603b and hence of the device 618 relative to the stationary member 603a (or the rigid component 601) around the axis of the rotational motion mechanism 603. The rotational motion mechanism 603 is driven by a motor 603m, which is connected to the computer system 909 via wires or by wireless means, and the computer system 909 may be configured to control the timing and speed of the rotational motion mechanism 603. The computer system 909 may control the rotational motion mechanism 603 as to complete one, two, or more intermittent rotations in the device 618.

When the device 618 is at one of intermittent positions, a group of rail tracks of the device 618 is configured to connect pairs of ends of rail tracks that are fixedly mounted.

It should be noted that the track switch mechanism 621 may be substituted by other track switch mechanism in the known techniques.

Referring to FIG. 20A, a device 619 comprises: two vertical boards 619a and 619d; a first group of rail tracks comprising a pair of curved rail tracks 619e and 619b; a second group of rail tracks comprising a pair of linear rail tracks 619c and 619f. All rail tracks 619e, 619b, 619c and 619f are configured to be fixedly connected to the vertical boards 619a and 619d. The boards and the rail tracks are configured to be rigidly connected to each other, so the device 619 may also be regarded as a rigid body.

Referring to FIG. 20B, a track switch mechanism 622 comprises a rotational motion mechanism 608 and a device 619. The rotational motion mechanism 608 comprises a moving member 608b and a stationary member 608a. The vertical boards 619a and 619d of the device 619 are fixedly connected to the moving member 608b via a connector 606. The stationary member 608a is fixedly connected to a rigid component 605 which comprises a vertical board. The rigid component 605 may be referred to as a support component. The rotational motion mechanism 608 may produce an intermittent rotation of the moving member 608b and hence of the device 619 relative to the stationary member 608a (or the rigid component 605) around the axis of the rotational motion mechanism 608. The rotational motion mechanism 608 is driven by a motor 608m, which is connected to the computer system 909 via wires or by wireless means, and the computer system 909 may be configured to control the timing and speed of the rotational motion mechanism 608. The computer system 909 may control the rotational motion mechanism 608 as to complete one, two, or more intermittent rotations in the device 619.

When the device 619 is at one of intermittent positions, a group of rail tracks of the device 619 is configured to connect pairs of ends of rail tracks that are fixedly mounted.

The track switch mechanism 621 is referred to as a track switch mechanism of type I. The track switch mechanism 622 is referred to as a track switch mechanism of type II.

It should be noted that the rigid components 618h and 618b rigidly connect the rails tracks 618a, 618c, 618d, 618e, 618f, 618g, 618k and 618m. It should be noted that the rigid components may be substituted by other shapes. Similarly, the vertical boards 619a and 619d may be substituted by other rigid connectors which rigidly connect the rail tracks 619e, 619b, 619c and 619f. The rigid components 601 and 605 may optionally have other shape. The rigid components 618h, 618b, 619a and 619d may be referred to as movable components. They are moved by the respective rotational motion mechanism. The rotational motion mechanism 603 or 608 may optionally be a motor. Each of these rotational motion mechanisms may be substituted by other type of motion mechanism.

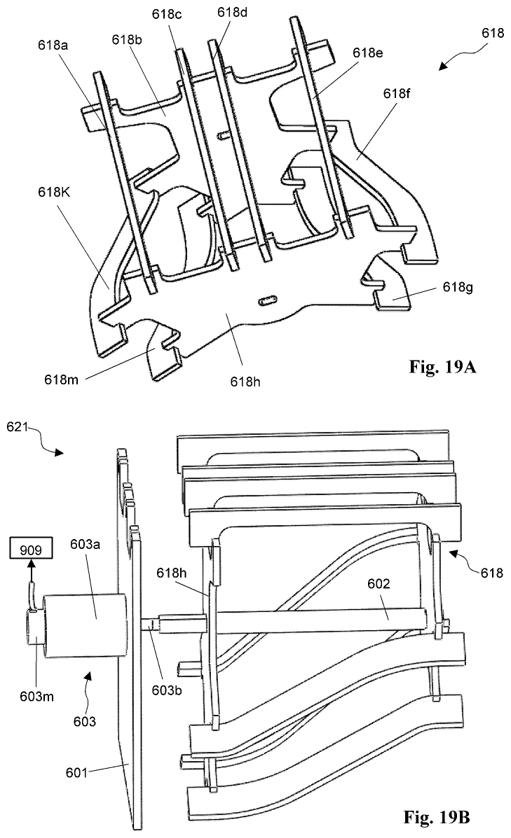

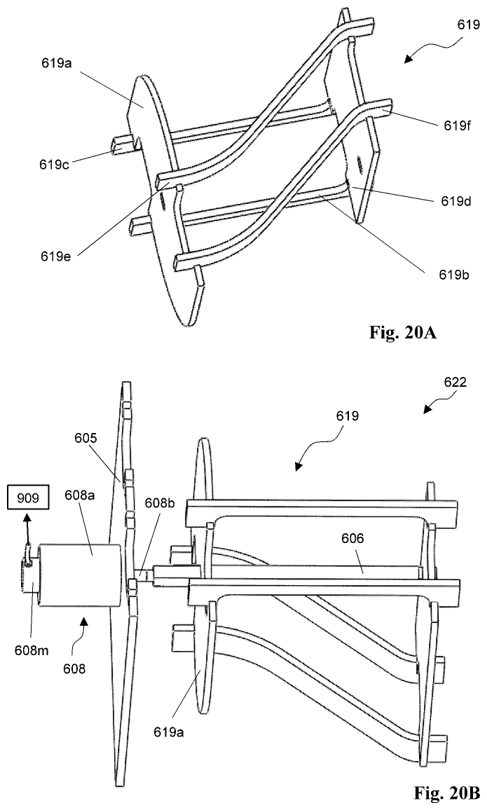

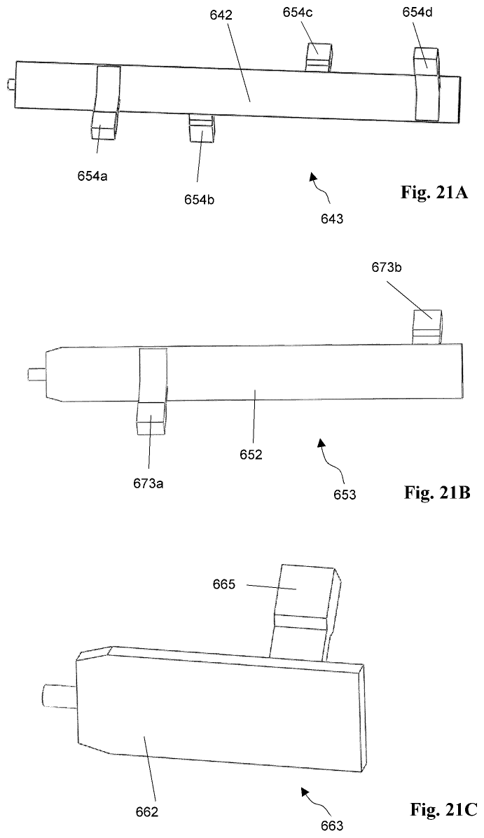

Referring to FIG. 21A, a stopping device 643 comprises: a rigid connector 642; and stoppers 654a, 654b, 654c and 654d, also referred to as barriers. The stoppers are all rigidly connected to the connector 642, so the stopping device 643 may be regarded as a rigid body. The rigid connector 642 has the shape of a board but this is not a strict requirement.

Referring to FIG. 21B, a stopping device 653 comprises: a rigid connector 652; and stoppers 673a and 673b, also referred to as barriers. The stoppers are all rigidly connected to the connector 652, so the stopping device 653 may be regarded as a rigid body. The rigid connector 652 has the shape of a board but this is not a strict requirement.

Referring to FIG. 21C, a stopping device 663 comprises a rigid connector 662 and a stopper 661, also referred to as barrier. The stopper 661 is rigidly connected to the connector 662, so the stopping device 663 may be regarded as a rigid body. The rigid connector 662 has the shape of a board but this is not a strict requirement.

Each of the stopper of the stopping device 643 (or 653, 663) comprises a ferromagnetic material which can be attracted by the magnet 783 on a vehicle 790.

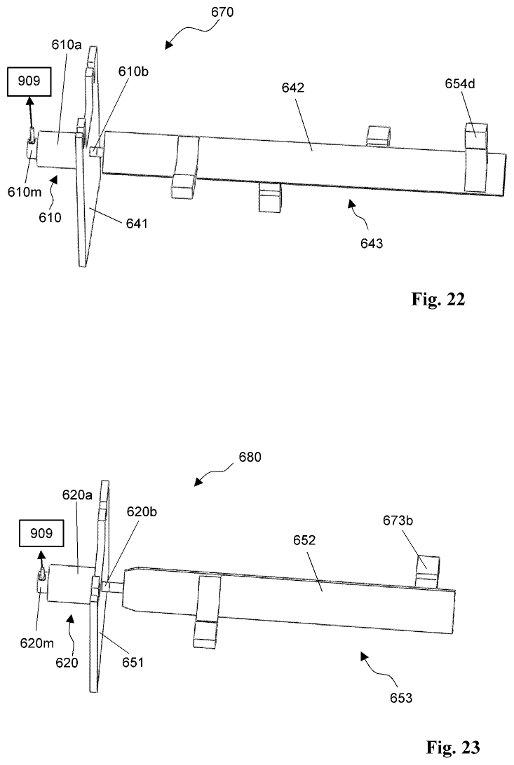

Referring to FIG. 22, a stopping mechanism 670 comprises a rotational motion mechanism 610 and the stopping device 643. The rotational motion mechanism 610 comprising a moving member 610b and a stationary member 610a. The moving member 610b is fixedly connected to the rigid connector 642 of the stopping device 643, and the stationary member 643a is fixedly connected to a rigid component 641, which may be referred to as a support component. The rotational motion mechanism 610 may produce an intermittent rotation of the stopping device 643 and the moving member 610b relative to the stationary member 610a (or equivalently, relative to the rigid component 641) around the axis of the axis of the rotational motion mechanism 610. The rigid connector 642 may be referred to as a movable component.

The rotational motion mechanism 610 is driven by a motor 610m, which is connected to the computer system 909 via wires or by wireless means, and the computer system 909 may be configured to control the timing and speed of the rotational motion mechanism 610. The computer system 909 is configured to keep track of the number of revolutions of the moving member 610b and to compute the position of the stopping device 643. The computer system 909 may control the rotational motion mechanism 610 as to complete one, two, or more intermittent rotations in the stopping device 643. The rotational motion mechanism 610 may optionally be a motor. The rotational motion mechanism may be substituted by other type of motion mechanism.

When the stopping device 643 is at one of four stopping positions, one of the stoppers 654a, 654b, 654c and 654d of the stopping device 643 is configured to be attracted by the magnet 783 on a vehicle 790 as to stop the vehicle 790 at a specific position; and the stopper functions as a physical barrier to prevent the rigid component 782 and hence the vehicle 790 from moving forward. The stopper is in physical contact with the rigid component 782 of the vehicle 790 when the vehicle is stopped.

Referring to FIG. 23, a stopping mechanism 680 comprises a rotational motion mechanism 620 and the stopping device 653. The rotational motion mechanism 620 comprising a moving member 620b and a stationary member 620a. The moving member 620b is fixedly connected to the rigid connector 652 of the stopping device 653, and the stationary member 620a is fixedly connected to a rigid component 651, which may be referred to as a support component. The rigid component 651 comprises a board. The rotational motion mechanism 620 may produce an intermittent rotation of the stopping device 653 and the moving member 620b relative to the stationary member 620a (or equivalently, relative to the support component 651) around the axis of the rotational motion mechanism 620. The rigid connector 652 may be referred to as a movable component.

The rotational motion mechanism 620 is driven by a motor 620m, which is connected to the computer system 909 via wires or by wireless means, and the computer system 909 may be configured to control the timing and speed of the rotational motion mechanism 620. The computer system 909 is configured to keep track of the number of revolutions of the moving member 620b and to compute the position of the stopping device 653. The computer system 909 may control the rotational motion mechanism 620 as to complete one, two, or more intermittent rotations in the stopping device 653. The rotational motion mechanism 620 may optionally be a motor. The rotational motion mechanism may be substituted by other type of motion mechanism.

When the stopping device 653 is at one of two stopping positions, one of the stoppers of the stopping device 653 is configured to be attracted by the magnet 783 on a vehicle 790 as to stop the vehicle 790 at a specific position, and the stopper functions as a physical barrier to prevent the rigid component 782 and hence the vehicle 790 from moving forward. The stopper is in physical contact with the rigid component 782 of the vehicle 790 when the vehicle is stopped.

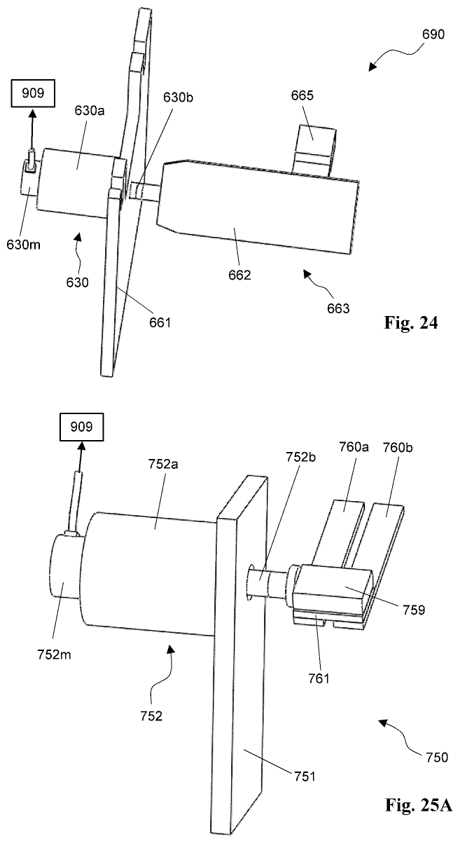

Referring to FIG. 24, a stopping mechanism 690 comprises a rotational motion mechanism 630 and the stopping device 663. The rotational motion mechanism 630 comprising a moving member 630b and a stationary member 630a. The moving member 630b is fixedly connected to the rigid connector 662 of the stopping device 663, and the stationary member 630a is fixedly connected to a rigid component 661 which comprises a board. The rigid component 661 is referred to as a support component. The rotational motion mechanism 630 may produce an intermittent rotation in the stopping device 663 relative to the stationary member 630a (or equivalently, relative to the rigid component 661) around the axis of the rotational motion mechanism 630. The rigid connector 662 may be referred to as a movable component.

The rotational motion mechanism 630 is driven by a motor 336m, which is connected to the computer system 909 via wires or by wireless means, and the computer system 909 may be configured to control the timing and speed of the rotational motion mechanism 630. The computer system 909 is configured to keep track of the number of revolutions of the moving member 630b and to compute the position of the stopping device 663. The computer system 909 may control the rotational motion mechanism 630 as to complete one, two, or more intermittent rotations in the stopping device 663. The rotational motion mechanism 630 may optionally be a motor. The rotational motion mechanism may be substituted by other type of motion mechanism.

When the stopping device 663 is moved to a stopping position, the stopper 665 of the stopping device 663 is configured to be attracted by the magnet 783 on a vehicle 790 as to stop the vehicle 790 at a specific position; and the stopper functions as a physical barrier to prevent the rigid component 782 and hence the vehicle 790 from moving forward. The stopper is in physical contact with the rigid component 782 of the vehicle 790 when the vehicle is stopped.

As explained earlier, when one of the stoppers of the stopping mechanisms 670 (or respectively 680, 690) is attracted by the magnet 783 of a vehicle 790, the computer system 909 is configured to send signals to the motor 84E of the driving wheel mechanism 765 as to stop the vehicle 790 at the position for a time period during which some mechanisms and apparatuses can complete a corresponding process.

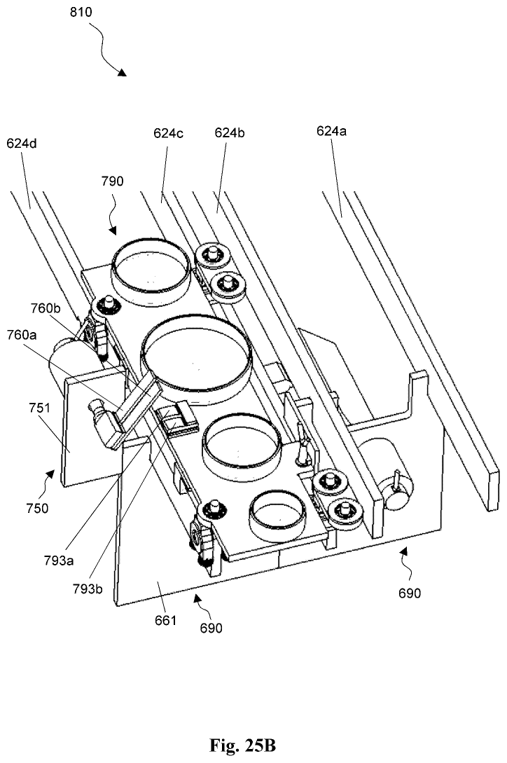

Referring to FIG. 25A, a charging sub-mechanism 750 comprises: a rigid connector 751 in the shape of a board; an insulation component 761 made of plastic or other electric insulating material; a pair of electrical outlets 760a and 760b connected to a power source by wires (not shown in figure); and a rotational motion mechanism 752. The pair of electrical outlets 760a and 760b are fixedly connected to a connector 759 by the insulation component 761, which is positioned between the electrical outlets and the connector 759. The rotational motion mechanism 752 comprises a moving member 752b and a stationary member 752a. The moving member 752b is fixedly connected to the connector 759, and the stationary member 752a is fixedly connected to a rigid component 751, referred to as a support component. As explained, the rigid component 751 has the shape of a board, though this is not a strict requirement. The connector 759 is referred to as a movable component. The rotational motion mechanism 752 may produce a back-and-forth rotation of the moving member 752b and hence of the movable component 759 and the electrical outlets 760a and 760b between a first end-position and a second end-position, relative to the stationary member 752a (or equivalently, relative to the connector 751). The rotational motion mechanism 752 is driven by a motor 752m, which is connected to the computer system 909 via wires or by wireless means, and the computer system 909 may be configured to control the timing and speed of the rotational motion mechanism 752. The rotational motion mechanism 752 may optionally be a motor. The rotational motion mechanism may be substituted by other type of motion mechanism.

When the pair of electrical outlets 760a and 760b are rotated around the axis of the rotational motion mechanism 752 to a first position of the back-and-forth rotation, the pair of electrical outlets 760a and 760b are configured to be moved away from the pair of electrical inlets 793a and 793b on a vehicle 790. Similarly, when the pair of electrical outlets 760a and 760b are rotated around the axis of the rotational motion mechanism 752 to a second position of the back-and-forth rotation, the pair of electrical outlets 760a and 760b are configured to touch the pair of electrical inlets 793a and 793b on a vehicle 790.

Each time, the pair of electrical outlets 760a and 760b are moved to the second position of the back-and-forth rotation, the rotational motion mechanism 752, under the control of the computer system 909, is stopped for a time period during which the charging sub-mechanism 750 completes a charging process. After this time, the rotational motion mechanism 752, under the control of the computer system 909, may restart again and make a reverse rotation to rotate the pair of electrical outlets 760a and 760b to the first position of the back-and-forth rotation.

Referring to FIG. 25B, a charging mechanism 810 comprises: two stopping mechanisms 690 and a charging sub-mechanism 750. The rigid component 661 of the stopping mechanisms 690 is configured to be fixedly connected to a pair of rail tracks 624c and 624d, and the rigid component 751 of the charging sub-mechanism 750 is rigidly connected to the rigid component 661 of the stopping mechanism 690. Another of the stopping mechanisms 690 is configured to be fixedly connected to a pair of rail tracks 624a and 624b.

A vehicle 790 may be stopped at a special position by the stopping mechanism 690 where the charging sub-mechanism 750 may charge the rechargeable battery 791 of the vehicle 790, when the magnet 783 of the vehicle 790 attracts the stopper 665 of the stopping mechanism 690. The computer 904 can send signals to stop the motors 84E of the driving wheel mechanisms 765, to control the rotational motion mechanism 752 of the charging sub-mechanism 750, hence to drive the rotation in the pair of electrical outlets 760a and 760b to touch the pair of electrical inlets 793a and 793b on a vehicle 790. Thus, the charging process may be controlled by the computer system 909.

It should be noted that the rigid components 651, 651 and 661 in the above stopping mechanisms may be substituted by other shapes. The rigid component 751 of the charging mechanism 750 be substituted by other shape.

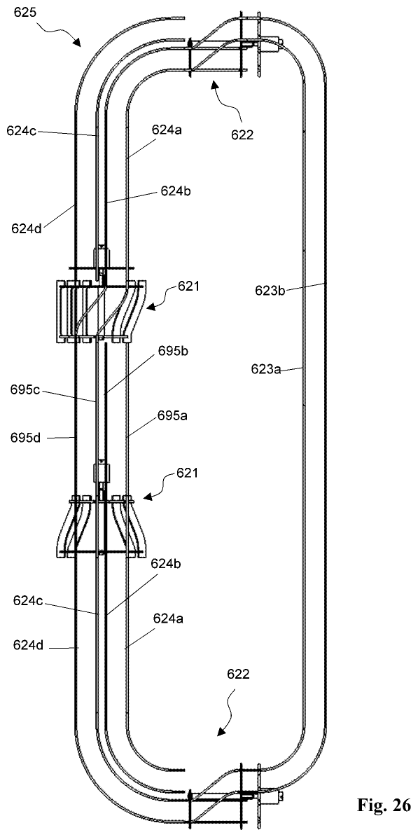

Referring to FIG. 26, a rail track system 625 comprises: a plurality of track switch mechanisms 621; a plurality of track switch mechanisms 622; a pair of rail tracks 623a and 623b; a pair of rail tracks 624a and 624b, and a pair of rail tracks 624c and 624d which run parallel to the pair of rail tracks 624a and 624b; a pair of rail tracks 695a and 695b, and a pair of rail tracks 695c and 695d which are parallel to the pair of rail tracks 695a and 695b. One track switch mechanism 621 is configured to be mounted in between: (1) the pairs of rail tracks, 624a and 624b, and 624c and 624d and, (2) the pairs of rail tracks, 695a and 695b, 695c and 695d. As shown in FIG. 27A, when the track switch mechanism 621 is at a first stopping position, the first group of rail tracks in the track switch mechanism 621 are configured to connect the pair of rail tracks 695a and 695b to the pair of rail tracks 624a and 624b, and also to connect the pair of rail tracks 695c and 695d to the pair of rail tracks 624c and 624d. As shown in FIG. 27B, when the track switch mechanism 621 is at a second stopping position, the second group of rail tracks in the track switch mechanism 621 are configured to connect the pair of rail tracks 695c and 695d to the pair of rail tracks 624a and 624b. As shown in FIG. 27C, when the track switch mechanism 621 is at a third stopping position, the third group of rail tracks in the track switch mechanism 622 are configured to connect the pair of rail tracks 695a and 695b to the pair of rail tracks 624c and 624d.

One of the track switch mechanisms 622 is configured to be mounted in between (1) the pair of rail tracks 623a and 623b, and (2) the pairs of rail tracks 624a and 624b, 624c and 624d. As shown in FIG. 28A, when the track switch mechanism 622 is at a first stopping position, the first group of rail tracks in the track switch mechanism 622 are configured to connect the pair of rail tracks 623a and 623b to the pair of rail tracks 624c and 624d. As shown in FIG. 28B, when the track switch mechanism 622 is at a second stopping position, the second group of rail tracks in the track switch mechanism 622 are configured to connect the pair of rail tracks 623a and 623b to the pair of rail tracks 624a and 624b.

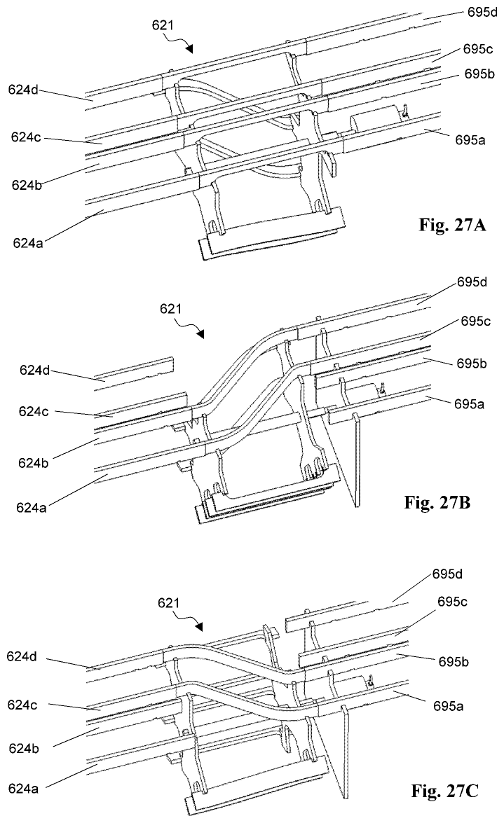

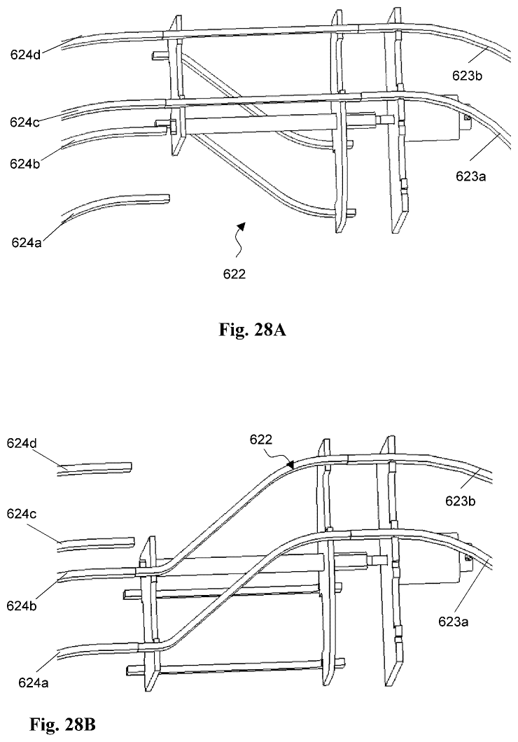

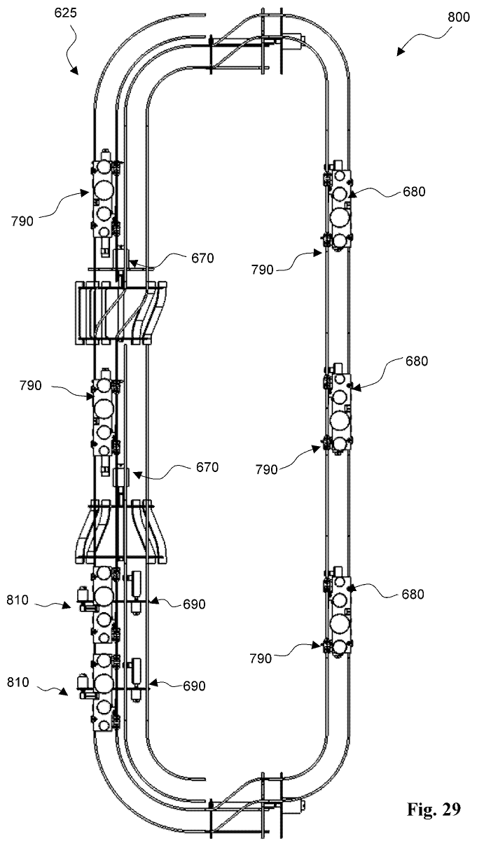

Referring to FIG. 29, a transport system 800 comprises: a rail track system 625; a plurality of vehicles 790; a plurality of charging mechanisms 810; a plurality of stopping mechanisms 680; and a plurality of stopping mechanisms 670. The stopping mechanisms 680 are mounted on the pair of rail tracks 623a and 623b of the rail track system 625. The stopping mechanisms 670 are mounted on the pair of rail tracks 624c and 624d and the pair of rail tracks 695c and 695d of the rail track system 625. The charging mechanisms 810 are mounted next to the pairs of rail tracks 624a and 624b, 624c and 624d. The transport system 800 is configured to transfer the container 107, either a container in another mechanism may be moved and be placed in one of the holding cups (785a,785b or 785c) or a container on one of the holding cups (785a,785b or 785c) is moved out of the holding cup and placed on another mechanism by a transfer apparatus.

It should be noted that for our applications, one may construct different types of rail track system, charging mechanisms, stopping mechanisms, or vehicles, using existing techniques.

It should be noted that the transport system 800 may be substituted by the cyclic transport apparatus disclosed in U.S. patent application Ser. No. 15/798,357, the disclosure of which is hereby incorporated herein by reference in its entirety.

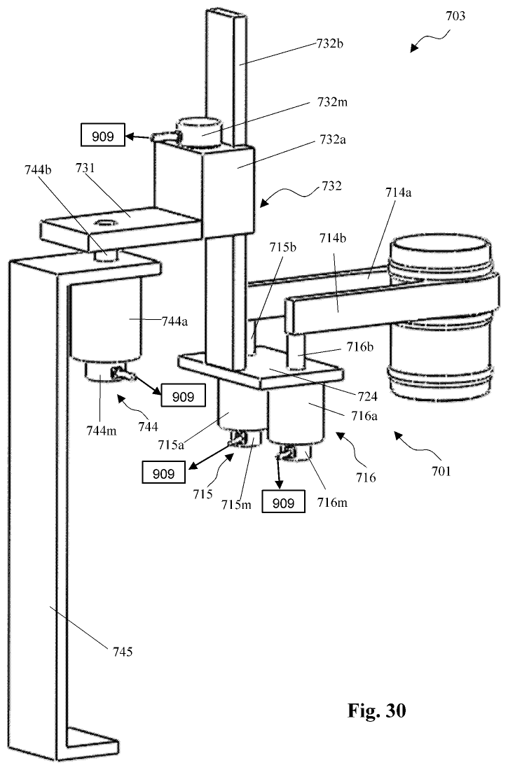

Referring to FIG. 30, a container transfer apparatus 703 comprises a container gripper mechanism 701 comprising: gripping devices (also referred to as grippers) 714a and 714b; rotational motion mechanisms 715 and 716. The gripping device 714a or 714b may comprise a rubber or silica gel or other elastic material. The rotational motion mechanism 715 comprises a stationary member 715a and a moving member 715b. The rotational motion mechanism 716 comprises a stationary member 716a and a moving member 716b. The stationary members 715a and 716a are rigidly or fixedly connected to a support component 724. The gripping device 714a is rigidly or fixedly connected to the moving member 715b. The rotational motion mechanism 715 can produce a rotation of the moving member 715b and hence of the gripping device 714a relative to the stationary member 715a. Similarly, the gripping device 714b is rigidly or fixedly connected to the moving member 716b. The rotational motion mechanism 716 can produce a rotation of the moving member 716b and hence of the gripping device 714b relative to the stationary member 716a. The rotational motion mechanisms 715 and 716 are configured to rotate the respective gripping devices 714a and 714b anti-synchronously around a pair of parallel axes. Each of the gripping devices 714a and 714b is rotated between a first end-position and a second end-position. At the first end-positions, the gripping devices 714a and 714b may together grip a container 107. At the second end-positions, the gripping devices 714a and 714b can open up and release the container.

The container transfer apparatus 703 further comprises a vertical motion mechanism 732 comprising a stationary member 732a and a moving member 732b which is configured to be moved vertically and linearly relative to the stationary member 732a. The moving member 732b is fixedly connected to the support component 724 of the container gripper mechanism 701. The vertical motion mechanism 732 can produce a vertical linear motion of the moving member 732b and hence of the support component 724 relative to the stationary member 732a. The container transfer apparatus 703 further comprises a rotational motion mechanism 744 comprising a stationary member 744a and a moving member 744b. The moving member 744b is fixedly connected to the stationary member 732a of the vertical motion mechanism 732 via a rigid connector 731, and the stationary member 744a is fixedly connected to the ground via a rigid connector 745. The rotational motion mechanism 744 may produce a back-and-forth rotation of the moving member 744b and hence of the stationary member 732a between two end-positions, relative to the stationary member 744a (or equivalently, relative to the rigid connector 745), around the axis of the rotational motion mechanism 744. The rotational motion mechanism 744 is connected to the computer system 909 via wires or by wireless means, and the computer system 909 may be configured to control the timing and speed of the rotational motion mechanism 744. The motion mechanism 715, 716, 732 or 744 is driven by a motor 715m, 716m, 732m or respectively 744m, which is connected to the computer system 909 via wires or by wireless means, and the computer system 909 may be configured to control the motions produced by the motion mechanisms of the container transfer apparatus 703. The container transfer apparatus 703 may be controlled by the computer system 909 to grip a container 107, and then move the container vertically, and then horizontally, and then release the container 107 at a different position.

The support component and rigid connectors 724, 731 and 745 are themselves rigid components. Then the container transfer apparatus 703 comprises the following:
(1) the container gripper mechanism 701 configured to grip or release a container 107, wherein the container gripper mechanism 701 comprises the rigid component 724, to be referred to as the base component of the container gripper mechanism 701, or the first support component of the container transfer apparatus 703. The container gripper mechanism 701 further comprises two gripping devices 714a and 714b which are constrained to rotate relative to the first support component 724 by a rotational motion mechanism; and each gripping device is configured to fit the ingredient container 107;
(2) the rigid connector 731, referred to as a second support component of the container transfer apparatus 703;
(3) the rigid connector 745, referred to as a third support component, or the base component of the container transfer apparatus 703;
(4) a vertical motion mechanism, referred to as a first motion mechanism, configured to produce a vertical linear motion in the first support component 724 relative to the second support component 731;
(5) a rotational motion mechanism, referred to as a second motion mechanism, configured to produce a rotation of the second support component 731 relative to the third support component 745, around a vertical axis (i.e., the axis of the rotational motion mechanism 744).

Although this is not a strict requirement, the distance between the axis of the rotational motion mechanism 744 and the axis of an ingredient container 107 may be configured to be a constant, when the ingredient container 107 is gripped by the container gripper mechanism 701 of the container transfer apparatus 703, as in FIG. 30. The constant is referred to as the radius of the container transfer apparatus 703. The container transfer apparatus 703 can be positioned in a proper position as to grip an ingredient container 107, when the axis of the ingredient container 107 is positioned vertically, and the distance from the axis of the ingredient container 107 to the axis of the rotational motion mechanism 744 is equal to the radius of the container transfer apparatus 703, and when the height of the ingredient container 107 is within a certain limit. The container transfer apparatus 703 may grip an ingredient container 107, and may move it linearly in vertical direction, or horizontally by a rotation around the axis of the rotational motion mechanism 744, or by a combination of both, and then it may release the ingredient container 107 at a position which is different from the previous position.

It should be noted that the container transfer apparatus 703 may be substituted by the transfer apparatus 222, wherein the container gripper mechanism 701 of the container transfer apparatus 703 is substituted by the gripper mechanism 221 of the transfer apparatus 222 or other gripper mechanism which may be configured to grip and loosen a container 107. The container transfer apparatus 703 may be substituted by a robot hand (substituting the gripper mechanism 701) joined by a robot arm (substituting the motion mechanisms 732 and 744).

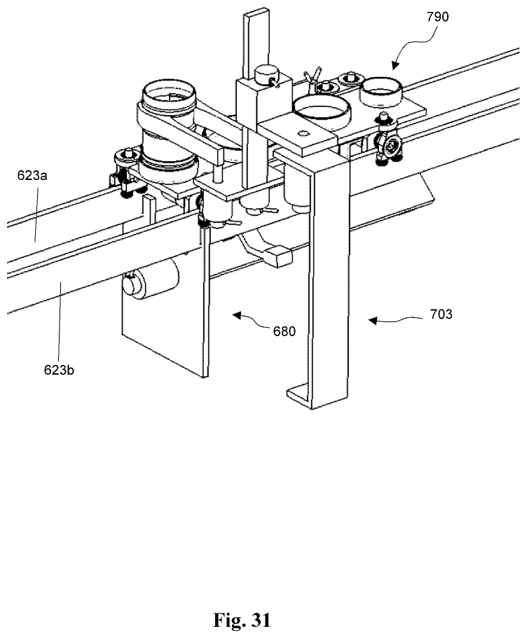

As shown in FIG. 31, the relative position of the stopping mechanism 680 and the base component of the container transfer apparatus 703 is configured to be properly fixed. When the vehicle 790 on the pair of rail tracks 623a and 623b is stopped at a position, the container transfer apparatus 703 is configured to transfer an emptied ingredient container from the holding cup of the vehicle 790 to another station, such as a cleaning station comprising a container cleaning apparatus (no shown in figures).

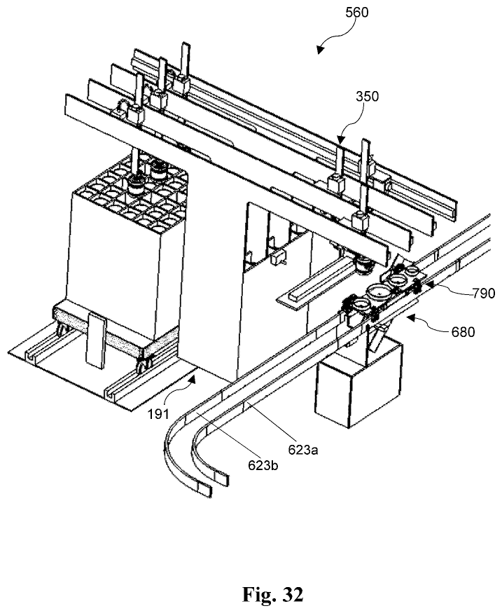

Referring to FIG. 32, a part of the transport system 800 is configured to pass through the storage station 560. A vehicle 790 on the pair of rail tracks 623a and 623b can be stopped at a position by the stopping mechanism 680, wherein one of stoppers of the stopping mechanism 680 is attracted by the magnet 783 on the vehicle 790. Then, the container transfer apparatus 350 can move an ingredient container 107 from the container holder 424 of the sub-apparatus 440 to a holding cup on the vehicle 790 of the transport system 800. The relative position of the stopping mechanism 680 and the storage apparatus 191 of the storage station 560 is relatively fixed and properly configured.

It should be noted that the magnet 783 of the vehicle 790 may be substituted by a ferromagnetic component, and each stopper of the stopping mechanisms above may be substituted by a component comprising a magnet.

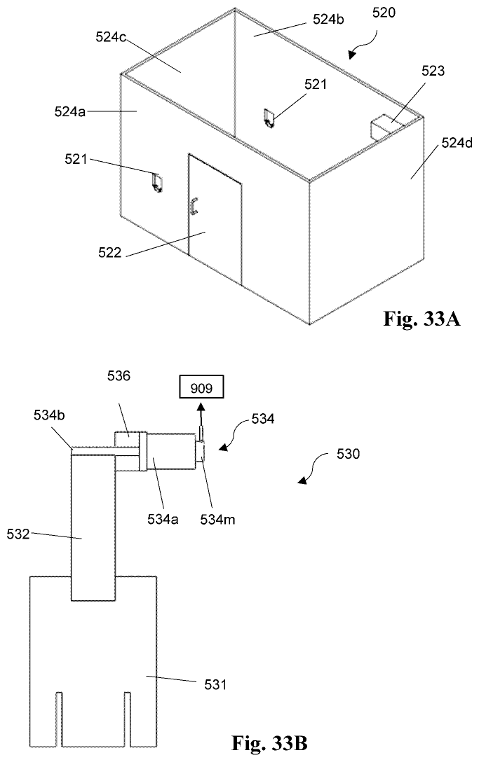

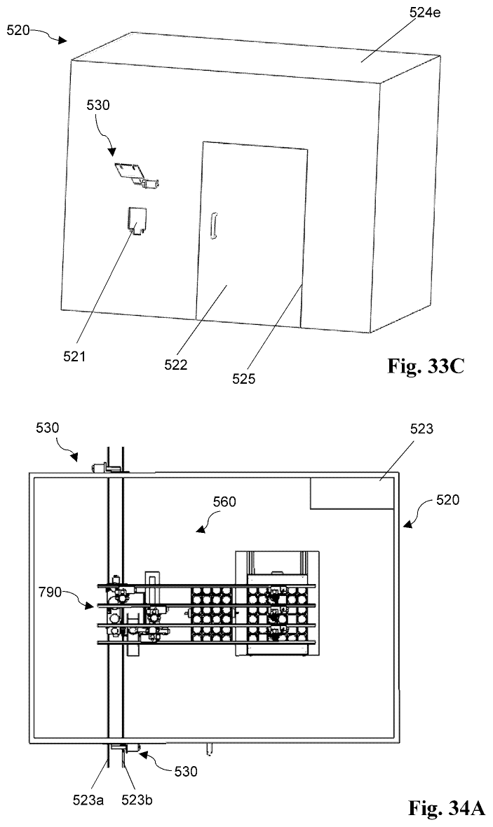

Referring to FIGS. 33A-33C, a storage room 520 comprises walls 524a, 524b, 524c and 524d, a roof 524e and a floor which encloses a heat insulated space. The walls, roof and floor comprise heat insulation material and the seams among them are properly sealed. Each of the walls 524a and 524b comprises an opening 521. Some rail tracks 623a and 623b of the transport system 800 are configured to be mounted as to pass through the bottom of the opening 521, so that a vehicle 790 may enter and/or leave the storage room 520 through the opening 521. A door 531 comprises a heat insulation material; wherein the door 531 may be used to cover the opening 521 as to limit air flow and heat flow between the storage room 520 and the outside.

A sealing mechanism 530 comprises: a rotational motion mechanism 534 comprising a moving member 534b and a stationary member 534a; a door 531; and a connector 532 which rigidly connects the moving member 534b to the door 531 (see FIG. 33B). The stationary member 534a is fixedly connected to the wall 524a or 524b by a connector 536. The rotational motion mechanism 534 can produce a back-and-forth rotation of the moving member 534b and hence of the door 531 relative to the stationary member 534a (or equivalently, relative to the wall 524a or 524b), between a first end-position and a second end-position. At the first end-position, the door 531 can cover the opening 521 as to limit air and heat flow between the storage room 520 and the outside through the opening 521. At the second end-position, the door 531 is moved away from the opening 521 so a vehicle 790 may pass through the opening 521 as to enter or leave the storage room 520.

The rotational motion mechanism 534 is driven by a motor 534m, which is connected to the computer system 909 via wires or wireless means, and the computer system 909 may be configured to dynamically control the timing and/or speed of the rotational motion mechanism 534.

In our applications the opening 521 is relatively small (compared doors for human entry). The opening 521 may be referred to as a window. The door 531 may also be referred to as a cover or window cover. The door 531 may have the shape of a board or other shape. The door 531 may be substituted by any type of barrier that can limit air flow and heat flow through opening 521; wherein the barrier may be moved away from the opening as to allow vehicles to pass through the opening.

It should be noted that the rotational motion mechanism 534 may be substituted by another type of motion mechanism that moves the door 531.

One of the walls of the storage room 520 has a regular sized opening 525 as to allow a transport cart 194 and/or a human to enter or leave the storage room; and a door 522 is mounted on the wall structure near the opening 525. The door 522 is partially comprised of heat insulation material. The door 522 may be operated by a human or by an automated mechanism.

The storage room 520 is kept cool by a refrigeration machine 523 (which is connected by a pipe to the outside of the storage room).

The refrigeration machine 523 is optionally connected to the computer system 909 via wires or by wireless means. The computer system 909 is configured to dynamically control the timing and/or power of the refrigeration machine 523. Some temperature sensors are also connected to the computer system 909 by wires. Under the control of the computer system 909, the temperature of the storage room 520 can be kept in a certain range.

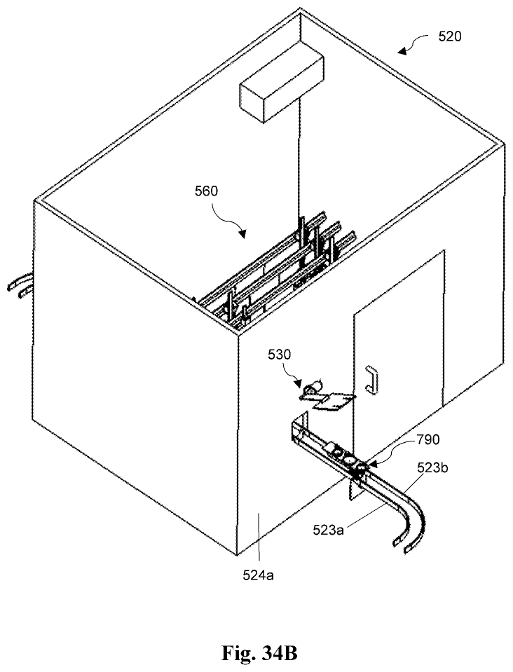

Referring to FIGS. 34A-34B, the storage station 560 is located inside the storage room 520. The temperature of the storage room 520 can be kept in a certain range by the refrigeration machine 523, so that the food ingredients contained in the closed containers of the storage station 560 may be kept fresh for longer period of time. The part of the transport system 800, as shown in FIG. 32, is also positioned inside the storage room 520. A vehicle 790 of the transport system 800 may pass through an opening 521 as to enter or leave the storage room 520.

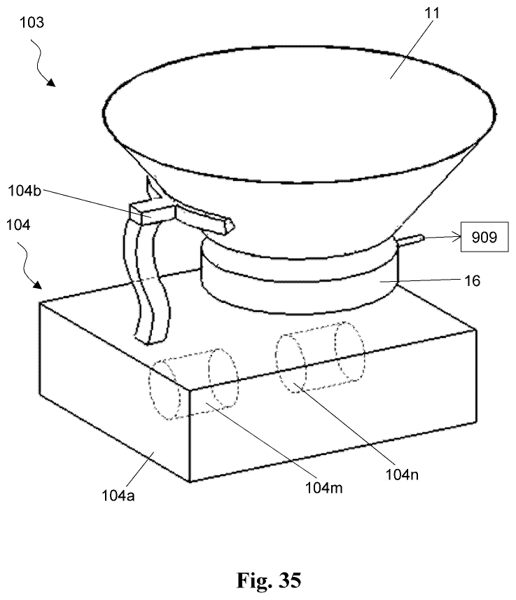

Referring to FIG. 35, a cooking apparatus 103 comprises: a cookware 11; a heater (such as inductive stove, gas burner, electric burner, etc.) 16; and a motion mechanism 104 comprising a stationary component 104a and a moving component 104b. The moving component 104b is rigidly, fixedly, or otherwise connected to the cookware 11 at least during time of operation. The heater 16 is configured to heat the cookware 11 and hence the food or food ingredients held in said cookware. The motion mechanism 104 may produce a motion of the cookware as to stir or mix the food or food ingredients in the cookware, using known techniques. For examples of such a motion mechanism, see, e.g., U.S. patent application Ser. Nos. 16/997,196, 15/706,136, 16/155,895, and 16/510,982, the disclosures of which are hereby incorporated herein by reference in their entireties. The motion mechanism 104 may also be able to produce a motion (e.g. a rotation around a horizontal axis) of the cookware 11 to dispense a cooked food from the cookware 11, using know techniques. The motion mechanism 104 is driven by motors 104m and 104n, which are connected to the computer system 909 by wires or by wireless means.

As an example, the motion mechanism 104 may comprise a robot arm, wherein a moving part of the robot arm is connected to the cookware. The connection to the cookware may be temporary or permanent, depending on particular application. For another example, see e.g., U.S. patent application Ser. No. 16/155,895, the disclosure of which is hereby incorporated herein by reference in its entirety.

It should be noted that the heater may optionally be fixedly connected to the cookware. See, e.g., U.S. patent application Ser. No. 15/801,923, the disclosures of which are hereby incorporated herein by reference in its entirety. In other applications, the heater may optionally be fixedly connected to the ground.

The motion mechanism 104 of the cooking apparatus 103 may be substituted by the stirring motion mechanism, the unloading mechanism, the dispensing apparatus, or the combination of the above, as disclosed in U.S. patent application Ser. Nos. 16/997,196, 15/706,136, 15/801,923, and 16/155,895. The Entire contents of the application are incorporated herein by reference.

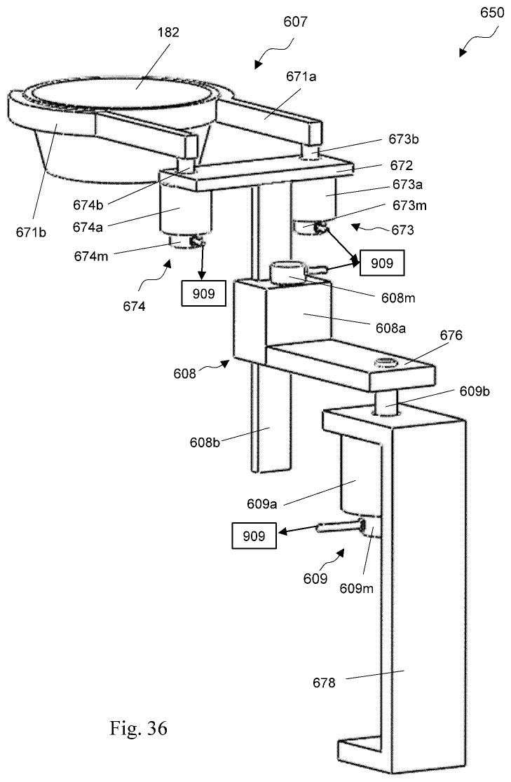

Referring to FIG. 36, a transfer apparatus 650 comprises a gripper mechanism 607 comprising: gripping devices (also referred to as grippers) 671a and 671b; rotational motion mechanism 673 and 674. The gripping device 671a or 671b may comprise a rubber or silica gel or other elastic material. The rotational motion mechanism 673 comprises a stationary member 673a and a moving member 673b. The rotational motion mechanism 674 comprises a stationary member 674a and a moving member 674b. The stationary members 673a and 674a are fixedly connected to a support component 672. The gripping device 671a is rigidly or fixedly connected to the moving member 673b. The rotational motion mechanism 673 can produce a rotation of the moving member 673b and hence of the gripping device 671a relative to the stationary members 673a. Similarly, the gripping device 671b is rigidly or fixedly connected to the moving member 674b. The rotational motion mechanism 674 can produce a rotation of the moving member 674b and hence of the gripping device 671b relative to the stationary members 674a. The axis of rotation of the rotational motion mechanism 673 is parallel to the axis of rotation of the rotational motion mechanism 674, and the rotational motion mechanisms 673 and 674 are configured to rotate the respective gripping devices 671a and 671b anti-synchronously around a pair of parallel axes. Each of the gripping devices 671a and 671b is rotated between a first end-position and a second end-position. At the first end-positions, the gripping devices 671a and 671b may together grip a food container 182. At the second end-positions, the gripping devices 671a and 671b can open up and release the food container 182.

The transfer apparatus 650 further comprises a vertical motion mechanism 608 comprising a stationary member 608a and a moving member 608b which is configured to be moved vertically and linearly relative to the stationary member 608a. The moving member 608b is rigidly or fixedly connected to the support component 672 of the gripper mechanism 607. The vertical motion mechanism 608 can produce a vertical linear motion of the moving member 608b and hence of the connector 724 relative to the stationary member 608a. The transfer apparatus 650 further comprises a rotational motion mechanism 609 comprising a stationary member 609a and a moving member 609b. The moving member 609b is rigidly or fixedly connected to the stationary member 608a of the vertical motion mechanism 608 via a connector 676, and the stationary member 609a is fixedly connected to the ground via a connector 678. The rotational motion mechanism 609 may produce a back-and-forth rotation of the moving member 609b and hence of the stationary member 608a between a first end-position and a second end-position, relative to the stationary member 609a (or equivalently, relative to the connector 678). The rotational motion mechanism 609 may be connected to the computer system 909 via wires or by wireless means, and the computer system 909 may be configured to control the timing and speed of the rotational motion mechanism 609. The motion mechanism 673, 674, 608 or 609 is driven by a motor 673m, 674m, 608m or respectively 609m, which is connected to the computer system 909 via wires or by wireless means, and the computer system 909 may be configured to control the motions produced by the motion mechanisms of the transfer apparatus 650. The transfer apparatus 650 may be controlled by the computer system 909 to grip a food container 182, and then move the food container vertically, and then horizontally, and then release the food container 182 at a different position.

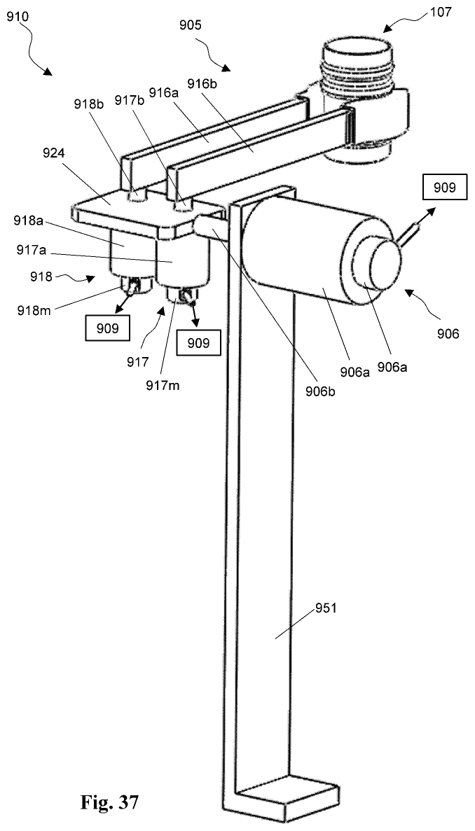

Referring to FIG. 37, a dispensing apparatus 910 comprises a gripper mechanism 905 comprising: gripping devices (also referred to as grippers) 916a and 916b; rotational motion mechanism 917 and 918. The gripping device 916a or 916b may comprise a rubber or silica gel or other elastic material. The rotational motion mechanism 918 comprises a stationary member 918a and a moving member 918b. The rotational motion mechanism 917 comprises a stationary member 917a and a moving member 917b. The stationary members 918a and 917a are fixedly connected to a support component 924. The gripping device 916a is rigidly or fixedly connected to the moving member 918b. The rotational motion mechanism 918 can produce a rotation of the moving member 918b and hence of the gripping device 916a relative to the stationary members 918a. Similarly, the gripping device 916b is rigidly or fixedly connected to the moving member 917b. The rotational motion mechanism 917 can produce a rotation of the moving member 917b and hence of the gripping device 916b relative to the stationary members 917a. The axis of rotation of the rotational motion mechanism 918 is parallel to the axis of rotation of the rotational motion mechanism 917, and the rotational motion mechanisms 918 and 917 are configured to rotate the respective gripping devices 916a and 916b anti-synchronously around a pair of parallel axes. Each of the gripping devices 916a and 916b is rotated between a first end-position and a second end-position. At the first end-positions, the gripping devices 916a and 916b may together grip a container 107. At the second end-positions, the gripping devices 916a and 916b can open up and release the container.

The dispensing apparatus 910 further comprises a rotational motion mechanism 906 comprising a stationary member 906a and a moving member 906b. The moving member 906b is rigidly or fixedly connected to the support component 924 of the container gripper mechanism 905, and the stationary member 906a is fixedly connected to the ground via a connector 951. The rotational motion mechanism 906 may produce a back-and-forth rotation of the moving member 906b and hence of the support component 924 between a first end-position and a second end-position, relative to the stationary member 906a (or equivalently, relative to the connector 951). The rotational motion mechanism 906, 917 or 918 is driven by a motor 906m, 917m or respectively 918m, which is connected to the computer system 909 via wires or by wireless means, and the computer system 909 may be configured to control the motions produced by the motion mechanisms of the dispensing apparatus 910. The dispensing apparatus 910 may be controlled by the computer system 909 to grip a container 107, and then rotate it a pre-assigned angle (e, g, 150 degrees) as to dispense the food or food ingredients contained in the container 107.

When the support component 924 of the container gripper mechanism 905 is rotated to the first end-position of the back-and-forth rotation, the gripping devices 916a and 916b in the container gripper mechanism 905 can be rotated to their first end-positions to grip a container 107, wherein the container 107 may contain or otherwise hold food or food ingredients. When the container 107 is gripped, the axis of the gripped container 107 is configured to be vertical (although this is not a strict requirement). When the container 107 is being gripped by the gripper mechanism 905, the computer system 909 would control the rotational motion mechanism 906 to rotate the support component 924 of the container gripper mechanism 905 to the second end-position. This way, the container 107 and the gripping devices 916a and 916b are rotated with the support component 924 and the food or food ingredients contained in the container 107 can be dispensed as the container 107 is turned. The angle of rotation from the first end-position to the second end-position is between 90 and 180 degrees (e.g., 150 degrees). After the dispensing of the food or food ingredients contained or held in the container 107, the gripped container and (the support component of) the container gripper mechanism 905 may be returned to the first end-position, when the rotational motion mechanism 906 rotates the support component 924 backward.

It should be noted that the dispensing apparatus 910 comprises:
(1) the support component 924, referred to as a first support component of the dispensing apparatus 910;
(2) the gripping devices 916a and 916b, each of which is rotatable relative to the first support component, wherein the axes of rotations of the gripping devices relative to the first support component are configured to be mutually parallel;
(3) the connector 951, referred to as a second support component;
(4) a rotational motion mechanism 906 configured to rotate the first support component 924 relative to the second support component 951, around the (horizontal) axis of the rotational motion mechanism 906;
(5) a gripper mechanism configured to grip and loosen a container 107.

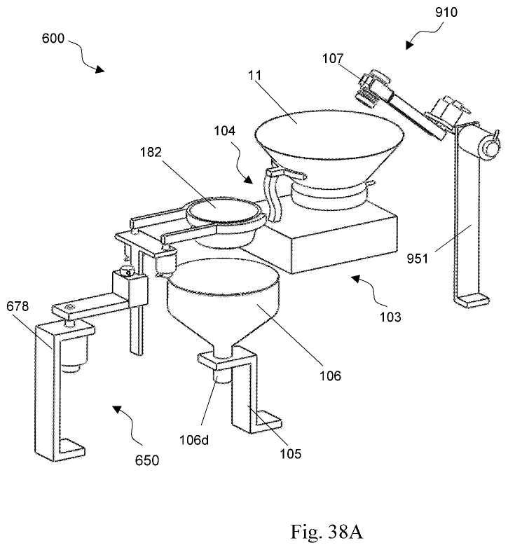

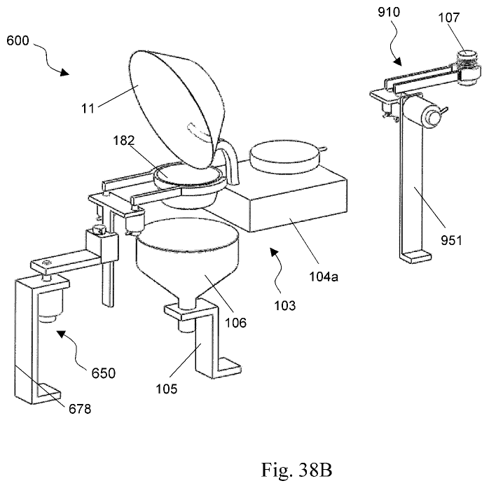

Referring to FIGS. 38A-38B, a cooking station 600 comprises: a cooking apparatus 103 (as in FIG. 35); a transfer apparatus 650 (as in FIG. 36); a sink 106 and a garbage disposal 106d which is connected to the sink, right below the sink; and a dispensing apparatus 910 (as in FIG. 37). The sink 106 and the garbage disposal are fixedly connected to the ground via a connector 105; and a pipe is connected to the garbage disposal to flow waste to a sewage or a wastewater tank. The positions of the support component 678 of the transfer apparatus 650, the connector 106, the support component of the cooking apparatus 103 and the support component 961 of the dispensing apparatus 910 are fixed relative to each other. When the support component 924 of the dispensing apparatus 910 is rotated to the second end-position, the food or food ingredients in the ingredient container 107 gripped and held by the dispensing apparatus 910 can be dispensed into the cookware 11 of the cooking apparatus 103 (see FIG. 38A). When the food container 182 gripped by the gripper mechanism 607 of the transfer apparatus 650 is moved to a receiving position, the cookware 11 of the cooking apparatus 103 can be rotated to a “dispensing position” by the motion mechanism 104, so that a cooked food held in the cookware 11 can be dispensed into the food container 182 (see FIG. 38B). When the gripped food container 182 is moved away from the receiving position. the cookware 11 of the cooking apparatus 103, in case it contains waste water, can be rotated to the dispensing position by the motion mechanism 104, to dispense the wastewater to the sink 106, which is connected to the garbage disposal and sewage or wastewater tank.

The cooking station 600 may further comprise a cleaning apparatus configured to clean the cookware 11 after a food is cooked; a lid apparatus configured to limit passage of air from and towards the cookware 11, or to limit the food or food ingredients from jumping out from the cookware 11 during a cooking process, and the lid apparatus comprises a liquid dispensing apparatus configured to dispense a plurality of liquid ingredients into the cookware 11 of the cooking apparatus; etc.

Examples of the cleaning apparatus and the lid apparatus are presented in the U.S. patent application Ser. No. 16/155,895, the disclosure of which is hereby incorporated herein by reference in its entirety.

It should be noted that the cooking apparatus 103 in the cooking station 600 may be substituted by other types of cooking apparatus. In particular, the cookware 11 and the motion mechanism in the cooking apparatus 103 may be substituted by other types of cookware and motion mechanisms. Same can be said on the lid apparatus, dispensing apparatus, cleaning apparatuses of the cooking station 600.

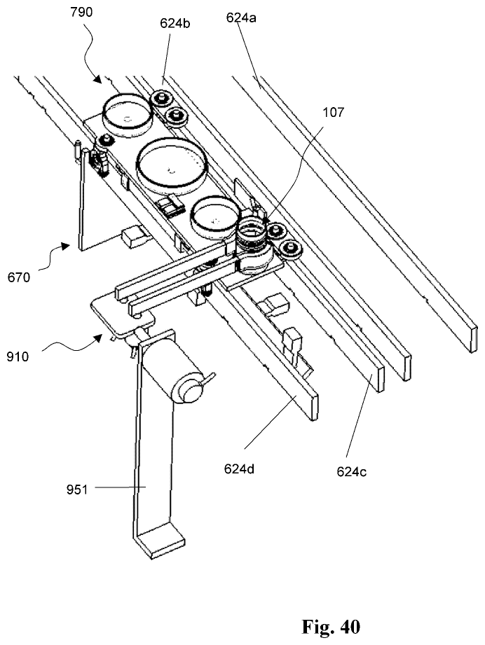

In some embodiments, referring to FIGS. 39-43, an automated kitchen system 400 comprises: a storage station 560; a transport system 800; a storage room 520; a refrigeration machine 523; a sealing mechanisms 530; a cooking station 600; and a cooking station 600x. The storage station 560 and a part of the transport system 800 are located inside the storage room 520, as previously shown in FIGS. 34A-34B.

The cooking station 600x is configured the same way as the cooking station 600. Thus, the cooking station 600x comprises: (1) a dispensing apparatus 910x which is configured the same way as the dispensing apparatus 910; (2) a cooking apparatus 103x, which is identically configured as the cooking apparatus 103. Thus, the cooking apparatus 103x comprises a cookware 11x; a motion mechanism comprising a support component, said motion mechanism being configured to produce a motion in the cookware 11x as to stir, mix or distribute the food or food ingredients contained in the cookware 11x, said motion mechanism configured to also move the cookware 11x as to dispense a cooked food from the cookware. The computer system 909 is configured to control the timing, direction or speed of the rotation of all motion mechanisms in the cooking station 600x.

The automated kitchen system 400 further comprises a transfer apparatus 703 configured to grip and move an emptied ingredient container 107 from a holding cup of the vehicle 790 to another position (see FIG. 31). The transfer apparatus 703 may be used to unload the emptied container and move the container into a collection box for emptied containers.

The base support components of various apparatuses on the automated kitchen system 400 need to be properly positioned.

The automated kitchen system 400 further comprises a computer system 909. The computers of the computer system 909 are connected to sensors via wires or by wireless means; wherein said sensors can be encoders, proximity switches, and temperature sensors, etc., of the cooking stations 600 and 600x, storage station 560, transport system 800, sealing mechanisms 530, and transfer apparatus 703. The computers of the computer system 909 are connected to electrical or electronic devices via wires or by wireless means; wherein said electrical or electronic devices can be various of types of motion mechanisms, electro-magnets inductive stoves or electric stoves, refrigeration apparatus of the cooking stations 600 and 600x, storage station 560, transport system 800, sealing mechanisms 530, and transfer apparatus 703. The computers of the computer system 909 are configured to control the functions of the electrical or electronic devices by sending signals to the electrical or electronic devices. The first computer 901 is configured to send signals to control the computers 902, 903 and 903x.

The computer 904 may optionally be connected to the computer system 909 by wireless means.

The closed ingredient containers 109 (or 109b) containing food ingredients may be previously placed in a transport cart 194, together with a plurality of other closed ingredient containers (usually of the same diametrical size). The transport cart 194 may be placed (e.g., by a human) in a certain fixed position in the storage apparatus 191 of the storage station 560, so that the container transfer apparatus 220 may be controlled by the computer system as to grip and transfer the ingredients containers in the transport box of the transport cart 194 to other locations.

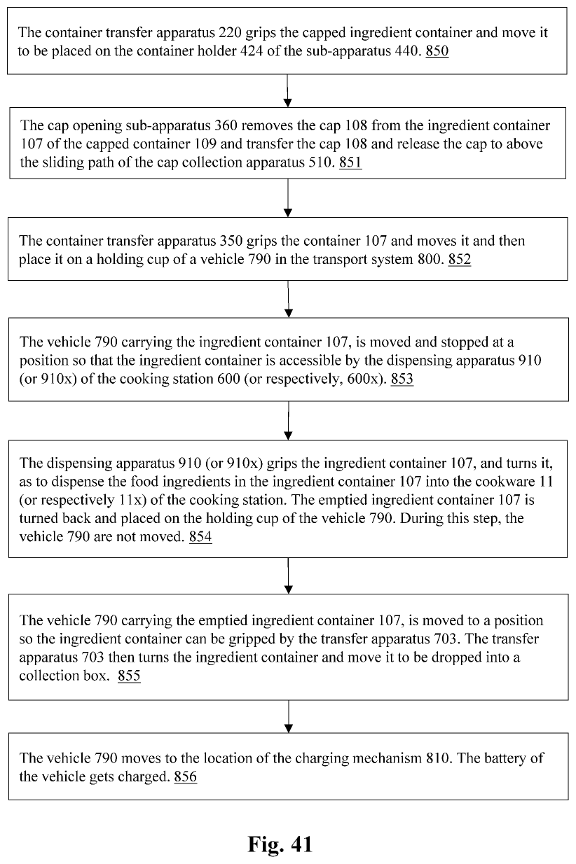

As shown in FIG. 41, the computer system 909 may control the transferring and dispensing of food ingredients from a closed ingredient container 109 (or 109b) by the following steps.

Step 850, the container transfer apparatus 220 grips the closed ingredient container 109 (or 109b) and move it to be placed on the container holder 424 of the sub-apparatus 440.

Step 851, the lid opening sub-apparatus 360 removes the cap 108 (or the lid 108b) from the ingredient container 107 of the closed container 109 (or 109b) and transfer the cap 108 (or the lid 108b) and release the cap to above the sliding path of the lid collection apparatus 510.

Step 852, the container transfer apparatus 350 grips the container 107 and moves it and then place it on a holding cup of a vehicle 790 in the transport system 800.

Step 853, the vehicle 790 carrying the ingredient container 107, is moved and stopped at a position so that the ingredient container is accessible by the dispensing apparatus 910 (or 910x) of the cooking station 600 (or respectively, 600x).

Step 854, the dispensing apparatus 910 (or 910x) grips the ingredient container 107, and turns it, as to dispense the food ingredients in the ingredient container 107 into the cookware 11 (or respectively 11x) of the cooking station. The emptied ingredient container 107 is turned back and placed on the holding cup of the vehicle 790. During this step, the vehicle 790 is not moved.

Step 855, the vehicle 790 carrying the emptied ingredient container 107, is moved to a position so the ingredient container can be gripped by the transfer apparatus 703. The transfer apparatus 703 then turns the ingredient container and move it to be dropped into a collection box.

Step 856, the vehicle 790 moves to the location of the charging mechanism 810. The battery of the vehicle gets charged.

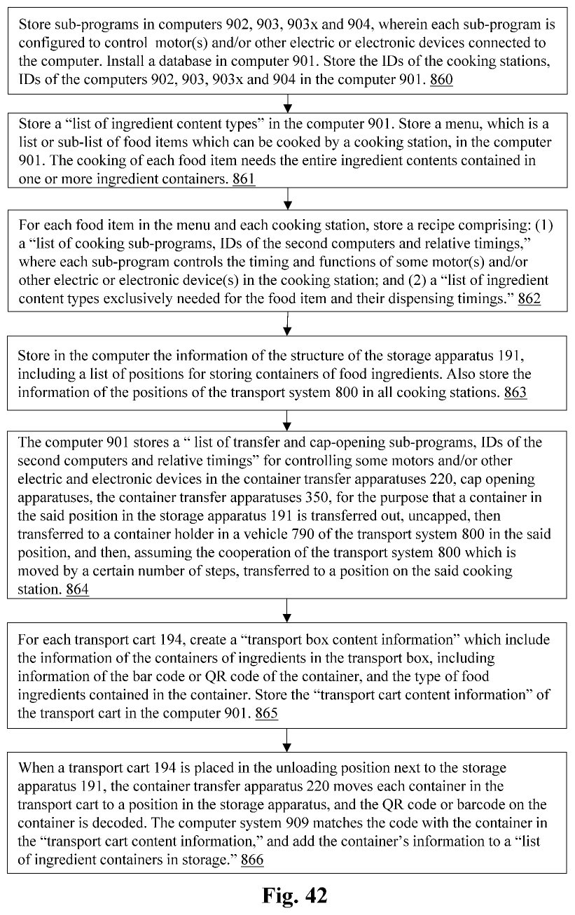

Referring to FIG. 42, the following tasks are performed by the computer system 909 or under the control of the computer system 909 of the kitchen system 400 before the business opens.

In Step 860, store some sub-programs in each of second computers (902, 903, and 903x) and computers 904 wherein each sub-program comprises procedures for the computer to control one or more motion mechanisms and/or other electric or electronic devices which are connected to the computers as to perform specific functions, and/or procedures for the computers to read the information of sensors or other electric or electronic devices, and then have the information sent to the first computer 901. The start time of a sub-program can be scheduled later, in accordance of needs. Also, install a database in the computer 901. The database will store some lists of data, including the lists as described in the following. Each cooking station (600 or 600x) is given an ID. The IDs of all cooking stations are stored in the computer 901. Each of second computers (902, 903, and 903x) and the computers 904 are given an ID. The IDs of the computers are stored in the computer 901.

In Step 861, store a list of “ingredient content types” in the computer 901. For example, an ingredient content type can be “20 oz. of sliced angus beef;” another ingredient content type can be “1.5 oz. of minced onion and 2 oz. of minced garlic.” In our applications, the content contained in an ingredient container comprises food ingredient(s) of an ingredient content type. Then the computer 901 stores a menu, which is a list or a sub-list of food items that can be cooked in the kitchen. The cooking of a single food item of the menu needs the entire content of food ingredients contained in one or more ingredient containers. This reduces the burden of dividing the food ingredients contained in an ingredient container.

It should be noted that the content of some ingredient containers may not belong to an “ingredient content type” stored in the computer 901.

In Step 862, for each food item in the menu and corresponding to each cooking station (600 or 600x), the computer 901 stores in its database: (1) a “list of cooking sub-programs, IDs of the second computers and relative timings” wherein each cooking sub-program is a program run by a computer (902, 903 or 903x) of a specific ID to control the functions of, and/or to receive information from some motor(s) and/or other electric or electronic device(s) in the cooking station (600 or 600x); and (2) a “list of ingredient content types exclusively needed for the food item and their dispensing timings” comprising a list of ingredient content types that are entirely needed for cooking the food item, and the relative timing for their dispensing into the cookware (11 or 11x) of the cooking station (600 or 600x), wherein the relative timing is relative to the start times of the sub-programs in the “list of cooking sub-programs, second computer IDs and relative timings”. The start time of a cooking sub-program may be fixed or limited relative to the start times of some or all of the other sub-programs in the same list, and the relations among various start times are included in the list; but the list does not include sub-programs controlling the transport system 800.

In Step 863, store the information of the storage apparatus 191 including a list of positions for storing containers of food ingredients, in the database of the computer 901. Also store the information of the positions of the transport system 800 in all cooking stations in the database of the computer 901.

In Step 864, for each position of the container in the storage apparatus 191, and for each position of the vehicles 790 in the transport system 800, and for each cooking station (600 or 600x), the computer 901 stores in its database a “list of transfer and cap-opening sub-programs, IDs of the second computers and relative timings” for controlling functions of some motion mechanism and/or other electric and electronic device(s) in the transfer apparatuses 220, the lid opening apparatus, the transport system 800, the container transfer apparatuses 350, for the purpose that a container in the position in the storage apparatus 191 is transferred out, and is unclosed by a lid opening apparatus, and then is transferred to a position on the vehicle 790 of the transport system 800. As before, a sub-program here may include procedures for reading the information of some of the sensors or other electric or electronic devices and have the information sent to the computer system 909. The timing of a sub-program in the list may be fixed or limited relative to the timings of some of the other sub-programs in the same list, and the relations among various timings are included in the list. In some applications, the start times of sub-programs controlling the transport system 800 need to be limited, but not necessarily fixed relative to the start times of other sub-programs.

In Step 865, for each transport cart 194, the computer 901 stores in its database a “transport cart content information” which include the information of the containers of ingredients in the transport cart 194, including information of the barcode or QR code of the container, and the type of food ingredients contained in the container.

In Step 866, when a closed container 109 (or 109b) is moved by the container transfer apparatus 220 from a transport cart 194 to a position in the storage box 192 of the storage apparatus 191, it passes through a position above the scanner 90F so that the scanner 90F can take an image of the QR code or barcode of the container, and then send the image to the computer system 909 as to decode the code. The computer system 909 matches the code with the container in the “transport cart content information,” and add the container to a “list of ingredient containers in storage,” which lists the container code, ingredient content type, position of the container in the storage apparatus 191.

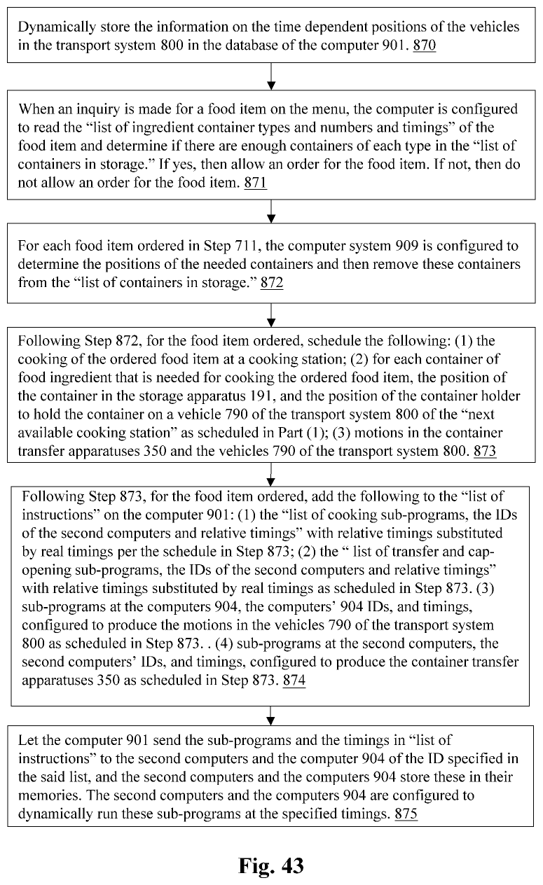

Referring to FIG. 43, the following tasks are performed by the computer system 909 of the kitchen system 400.

In Step 870, the computer system 909 is configured to dynamically record in the database of the computer 901 the time dependent positions of the vehicles 790 in the transport system 800. The transport system 800 may optionally be run on a fixed schedule with exact timings, and in this case the information on the exact position of each holding cup of the vehicle 790 in the transport system 800 at any time is stored in the database of the computer 901.

In Step 871, when an inquiry is made for availability of a food item of the menu, usually by a person using another computer which is connected to the computer system 909, the computer system 909 is configured to read the “list of ingredient content types and numbers” of the food item and determine if there are enough containers containing the ingredient content types and numbers in the “list of containers of food ingredient in the storage apparatus 191” as required to cook the food item. If yes, then allow an order for the food item. If not, then do not allow an order for the food item.

In Step 872, for a food item ordered in Step 871, the computer system 909 determines the positions of the (closed) ingredient containers 109 (or 109b) in the storage apparatus 191 which are needed for cooking the food item and remove these containers from the “list of ingredient containers in storage.” If facing multiple choices, the computer system 909 may be programmed to prioritize the ingredient containers which are positioned above the other ingredient containers in the same compartment of the storage apparatus 191.

In Step 873, following Step 872, for the food item ordered, the computer system 909 is configured to schedule the following: (1) the cooking of the next ordered food item at a cooking station 600 or 600x, which can be a next available cooking station; (2) for each ingredient container containing the food ingredient that is needed for cooking the ordered food item, the position of the closed ingredient container 109 (or 109b) in the storage apparatus 191, the lid opening apparatus to uncap the closed container 109 (or 109b), the position of the holding cup of the vehicle 790 in the transport system 800 at which position the open container 107 can be transferred to the holding cup of the vehicle 790; (3) motions of the container transfer apparatus 350 in the process of transferring the ingredient containers to their destinations at which position the ingredient containers can be transferred by the vehicle 790; (4) motions of the vehicle 790 in the process of transferring the ingredient containers to their destinations at which position the ingredients can be dispensed to the cookware 11 or 11x of the cooking station. The above schedule includes the start time of each sub-program in the list of cooking sub-programs or in the list of transfer and cap-opening sub-programs. The schedule also includes the timings for the ingredient containers to be transferred to and transferred out of the transport system 800.

In Step 874, the database of the computer 901 comprises a “list of instructions,” where each instruction includes a sub-program, the timing of the sub-program, and the identity of the second computer (902, 903, or 903x) to run the sub-program. Following Step 873, the computer system 909 adds the following to the list of instructions: (1) the “list of cooking sub-programs, the IDs of the second computers and relative timings” corresponding to the ordered food item, with times and IDs of the second computers scheduled in Step 873; (2) the “list of transfer and cap-opening sub-programs, IDs of the second computers and relative timings” with specified start times and IDs of the second computers as scheduled in Step 873; (3) sub-programs at the second computer (902, 903, or 903x) and timings, as to produce the necessary motions of container transfer apparatuses 350 as scheduled in Step 873; wherein the information of the IDs of the second computers are included in the schedule; (4) sub-programs at the computers 904 and timings, as to produce the necessary motions of the vehicle 790 as scheduled in Step 873; wherein the information of the IDs of the computers 904 are included in the schedule.

In Step 875, the computer system 909 is configured to send the sub-program and timing in each new instruction in the “list of instructions” to the second computers (902, 903, and 903x), and the computers 904 whose IDs are listed in the instruction; and the information are stored by the second computer and the computers 904. The second computers (902, 903, and 903x) and the computers 904 are configured to dynamically run the sub-programs at specified timings as sent to them by the computer system 909. The computer system 909 is configured to communicate with the second computers and the computers 904, so that the instructions as described above can be sent by the first computer 901 to the second computers, and so that the information of the sensors and other electric or electronic devices received by the second computers and the computers 904 can be sent to the computer system 909 per instructions. There are known techniques to achieve such communications, whether by wires or by wireless means.

In the above discussed kitchen systems, the dispensing apparatus is configured to dispense all the food ingredients in an opened ingredient container at once.

It should be noted that a motor in the present patent application may be an AC or DC motor, stepper motor, servo motor, inverter motor, pneumatic or hydraulic motor, etc. A motor may optionally further comprise a speed reducer, encoder, and/or proximity sensor.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

A support component described in the present patent application can be any type of rigid component. A support component may be moved or fixed relative to the ground. A rigid component may comprise one or more of the following: a bar, a tube, a beam, a board, a frame, a structure, a bearing housing, a shaft. A rigid component can be made by metal such as steel or aluminum, or by other materials, or by a combination of several types of materials.

Only a few examples and implementations are described. Other implementations, variations, modifications and enhancements to the described examples and implementations may be made without deviating from the spirit of the present invention. For example, the term cookware is used to generally refer to a device for containing or holding food ingredients during cooking. For the purpose of present patent application, a cookware can be a wok, a pot, a pan, a basket, a bowl, a container, a board, a rack, a net, or any object used to contain or otherwise hold food or food ingredients during a cooking process. The cooking also is not limited to any particular ethnic styles. The cooking may include but is not limited to frying (including stir frying), steaming, boiling, roasting, baking, smoking, microwaving, etc. The cooking apparatus may or may not use a heater.

Similarly, a food container, ingredient container, or container, can be a bowl, a plate, a cup, ajar, a bottle, a flat or curved board, a basket, a net, a wok, a pan, or any object used to contain or otherwise hold a food or food ingredients. A container can have a rather arbitrary geometric shape.

A gripper is a device used to touch and grip an object such as a container. A gripper can be a rigid or elastic object as in FIGS. 7A-7E. A gripper may be a vacuum chuck, as in FIG. 9A.

A gripper mechanism can be any mechanism that can be used to grip an object. A gripper mechanism may comprise a gripper such as a vacuum chuck. A gripper mechanism may alternatively comprise a plurality of rigid or elastic grippers which are moved to grip an object. A gripper mechanism may comprise a robot hand. In fact, any robot hand may be used as a gripper mechanism for our purposes.

A motion mechanism can be any mechanism that can be used to produce a movement of an object, which may be a component of the motion mechanism or an object that is rigidly or fixedly connected to a component of the motion mechanism. A motion mechanism may produce a linear motion of a component. A motion mechanism may produce a rotation of a component. A motion mechanism may comprise a robot arm. A motion mechanism may be a combination motion mechanism comprising a plurality of motion sub-mechanisms. A motion mechanism may comprise: a crank rod mechanism; eccentric motion mechanism; etc. A motion mechanism may comprise one or more the following parts: motor; encoder; shaft; coupling; bearing housing; bearings and accessories; gear and rack; screw rod and screw nut; cylinder; hydraulic cylinder; electromagnet; coupling; cam; eccentric shaft; bearing housing; bearings and accessories; Geneva mechanism, etc. Motion mechanisms can be more complex and the motions produced by a motion mechanism can be a planar motion, a spherical motion, an oscillatory or vibratory motion, see e.g., U.S. patent application Ser. Nos. 16/997,196, 15/706,136 (in this application a motion mechanism may be referred to as a transport mechanism), Ser. Nos. 15/801,923, and 15/798,357. Entire contents of the above applications are hereby incorporated herein by reference. It should be noted that the linear motion produced by the linear motion mechanism may be a linear motion between two end-positions or a linear motion with multiple stop positions. Any robot arm may be used as a gripper mechanism for our purposes.

A transfer apparatus can be any apparatus that can be used to transfer an object (such as a container) from one position to another. A transfer apparatus may comprise: a gripper mechanism comprising a support component and one or more grippers; and a combination motion mechanism which is a combination of a plurality of motion sub-mechanisms, said combination motion mechanism being configured to move the support component of the gripper mechanism. A transfer apparatus may comprise a robot arm and a gripper mechanism. A robot comprising a combination of a robot arm and a robot hand may be used as a transfer apparatus for our purposes.

An ingredient dispensing apparatus can be any apparatus that can be used to dispense food or food ingredients from an ingredient container into a cookware. A typical dispensing apparatus of food or food ingredients may comprise: a gripper mechanism configured to grip an ingredient container, and a motion mechanism configured to move a (support) component of gripper mechanism. More examples in U.S. patent application Ser. No. 15/157,319 (now U.S. Pat. No. 10,455,987) and Ser. No. 15/798,357. In particular, a robot comprising a robot hand and robot arm may be used as an ingredient dispensing apparatus. This is often used in prior art.

A food dispensing apparatus can be any apparatus that can be used to dispense a cooked (or semi-cooked) food from a cookware into another container. A food dispensing apparatus may comprise a motion mechanism which moves the cookware. A food dispensing apparatus may alternatively comprise a robot comprising a robot arm and robot hand that moves the cookware, and this is often the case when the cookware is not attached to another (relatively heavy) mechanism. Similarly, some transfer apparatus may be used as a food dispensing apparatus, and this is often the case when the cookware is not attached to another (relatively heavy) mechanism.

There is a difference between transfer apparatus and ingredient (or food) dispensing apparatus: a transfer apparatus usually keeps a gripped container in a fixed upright position, while a dispensing apparatus may turn a gripped container upside down or by some angle of say, 90 to 180 degrees.

Each vertical motion mechanism as described above may be substituted by a motion mechanism which can produce a linear or non-linear motion in an upward or downward direction, where an upward direction needs not to be exactly vertical. It can have an inclination angle between 0 and 90 degrees. Same applies to each horizontal motion mechanism described above.

A liquid dispensing apparatus can be any apparatus that can be used to dispense a liquid ingredient from a container into a cookware. A liquid dispensing apparatus may comprise liquid pipes, a liquid pump, a valve, and/or flow sensors, etc. More examples in U.S. patent application Ser. No. 15/157,319 (now U.S. Pat. No. 10,455,987).

A cooking apparatus can be any apparatus comprising a cookware. A cooking station may optionally further comprise a motion mechanism configured to move the cookware. The motion mechanism may optionally comprise a motion sub-mechanism configured to move the cookware as to stir food or food ingredients in the cookware. The motion mechanism may optionally comprise a motion sub-mechanism configured to move the cookware as to dispense a cooked (or semi-cooked) food from the cookware. A cooking station may optionally comprise a transfer apparatus configured to move the cookware. Said transfer apparatus may optionally grip the cookware as to dispense a cooked (or semi-cooked) food from the cookware. Examples of cooking apparatuses are given in U.S. patent application Ser. Nos. 16/997,196, 15/706,136, 16/155,895, 15/801,923, 15/869,805, and 15/157,319 (now U.S. Pat. No. 10,455,987), the entire disclosures of which are hereby incorporated herein by reference.

A cleaning apparatus can be any apparatus that can be used to clean an object, e.g., a funnel, or a container such as cookware, food container, or ingredient container. A cleaning apparatus comprises a liquid source (e.g., tap water, or a water tank) and a liquid pipe to flow the liquid from the source to the object; wherein the liquid flow may be controlled by a valve, a liquid pump, and/or by other known techniques; wherein the liquid may be referred to as a cleaning liquid, such as hot water, for the purpose of cleaning the object. In some applications, the liquid may be sprayed on the object by high speed but this is not a requirement. A cleaning apparatus may optionally further comprise a stirrer which is rotated to stir the cleaning liquid in the object, e.g., a container, which is cleaned by the cleaning apparatus. A cleaning apparatus may optionally comprise a motion mechanism configured to move the water pipes and stirrers away from or towards the object, which is cleaned or respectively to be cleaned by the cleaning apparatus.

A cooking station can be any system comprising a cooking apparatus. A cooking station may optionally comprise an ingredient dispensing apparatus, a liquid dispensing apparatus, and/or a cleaning apparatus. A cooking apparatus by itself may be considered as a cooking station.

A transport system can be any system that can be used to transfer a container (such as, an ingredient container, a food container, or a cooking container, i.e., a cookware). In some applications (but not always), a transport system can move a container after said container is placed on a member of the transport system. For example, a transport system may include a plurality of vehicles each configured to carry and transport a container; wherein the vehicles may optionally move on rail tracks. A transport system may optionally comprise a rotating turntable, or a cyclic motion mechanism, a chain, and/or a belt. Examples of transport system are given in U.S. patent application Ser. No. 15/157,319 (now U.S. Pat. No. 10,455,987), Ser. Nos. 15/798,357 and 16/155,895, the entire disclosures of which are hereby incorporated herein by reference.

A transport system may only comprise a transfer apparatus. A transfer apparatus is a special example of a transport system.

A container transfer apparatus can be any transfer apparatus used to move a container to a (different) member of a transport system. The container transfer apparatus can optionally be a part of said transport system.

A storage apparatus means a storage.

A heater for the purpose of cooking in the known technique may substitute any stove and heater disclosed in the present application.

Control by a computer or computer system of a motor, an actuator, a heater, or electrical or electronic devices are by known techniques.

In our patent application, a computer system may or may not comprise a network. A computer system may be a single computer in some simpler applications.

For the purpose of the present patent application, a connection of a computer (or computer system) and an electric or electronic component may compromise a wired and/or wireless connection between the computer (or computer system) and the electric or electronic device, as to allow the computer to communicate with said electric or electronic component. A connection of a computer (or computer system) and a mechanism or apparatus may comprise a wired and/or wireless connection between the computer (or computer system) and some (or all) of the electric or electronic components of the mechanism or apparatus as to allow the computer to communicate with said electric or electronic components.

What is claimed is:

1. A kitchen system, comprising:
a plurality of ingredient containers, each configured to contain or hold food ingredients;
a cooking station comprising:
a cookware configured to contain or otherwise hold food or food ingredients;
a motion mechanism configured to move the cookware, said motion mechanism comprising a motor or other driving mechanism; and
a dispensing apparatus configured to move an ingredient container as to dispense the food ingredients from the ingredient container to said cookware, said dispensing apparatus comprising:
a gripper mechanism comprising support component and one or more grippers, said gripper mechanism being configured to grip an ingredient container;
a motion mechanism configured to move the support component of the gripper mechanism, said motion mechanism comprising a motor or other driving mechanism;
a storage station comprising:
a storage configured to store said ingredient containers; and
a container transfer apparatus comprising:
a gripper mechanism comprising a support component and one or more grippers, said gripper mechanism being configured to grip an ingredient container; and
a motion mechanism configured to move the support component of the gripper mechanism, said motion mechanism comprising a motor or other driving mechanism; and
a plurality of vehicles each configured to transport one or more said ingredient containers from station to station;
wherein the container transfer apparatus of the storage station is configured to grip and move an ingredient container as to place the container on a said vehicle.

2. The kitchen system of claim 1, further comprising rail tracks configured to connect the cooking station and the storage station, wherein said vehicles are configured to move on the rail tracks.

3. The kitchen system of claim 2, further comprising a track switch mechanism, said track switch mechanism being configured to be connected to the computer system as to allow the computer system to control the track switch mechanism.

4. The kitchen system of claim 2, wherein each said vehicle comprises a ferromagnetic or magnetic component, said kitchen system further comprising a stopping mechanism configured to stop a said vehicle, said stopping mechanism comprising:
a support component;
a stopping device comprising one or more ferromagnetic or magnetic components each configured to attract the ferromagnetic component of a said vehicle;
a motion mechanism configured to move said stopping device, said motion mechanism comprising a motor or a driving mechanism.

5. The kitchens system of claim 1, wherein the computer system is configured to control the vehicles via wireless communication.

6. The kitchen system of claim 1, wherein the computer system is configured to store a list of food items and a cooking program for cooking any food items, said program being configured to allow the computer system to control the electric or electronic devices in the kitchen system which are connected to the computer system.

7. The kitchen system of claim 1, wherein the motion mechanism of the dispensing apparatus of the cooking station comprises:
a first motion sub-mechanism comprising a moving member, a stationary member, and a driving mechanism configured to move the moving member relative to the stationary member; and
a second motion sub-mechanism comprising a moving member, a stationary member, and a driving mechanism configured to move the moving member relative to the stationary member;
wherein the stationary member of the first motion sub-mechanism is configured to be rigidly or fixedly connected to the moving member of the second motion sub-mechanism.

8. The kitchen system of claim 1, wherein the motion mechanism of the container transfer apparatus of the storage station comprises:
a first motion sub-mechanism comprising a moving member, a stationary member, and a driving mechanism configured to move the moving member relative to the stationary member; and
a second motion sub-mechanism comprising a moving member, a stationary member, and a driving mechanism configured to move the moving member relative to the stationary member;
wherein the stationary member of the first motion sub-mechanism is configured to be rigidly or fixedly connected to the moving member of the second motion sub-mechanism.

9. The kitchen system of claim 9, further comprising a container transfer apparatus configured to unload a container from a said vehicle, said container transfer apparatus comprising:
a gripper mechanism comprising a rigid component as a support component and one or more grippers, said gripper mechanism being configured to grip an ingredient container; and
a motion mechanism configured to move the move the support component of the gripper mechanism, said motion mechanism comprising a motor or other driving mechanism.

10. The kitchen system of claim 1, wherein the motion mechanism of the dispensing apparatus of the cooking station is configured to be a rotational motion mechanism.

11. The kitchen system of claim 1, wherein the computer system is configured to dynamically track the quantities of the food ingredients held in the storage station.

12. The kitchen system of claim 1, wherein the dispensing apparatus of the cooking station comprises a robot arm combined with robot figures.

13. A kitchen system, comprising:
a computer system comprising one or more computers;
a plurality of ingredient containers, each configured to contain food or food ingredients;
a plurality of lids, each configured to close a said ingredient container;
a refrigerated storage room;
a storage station configured to be located in said storage room, said storage station comprising:
a storage configured to store said ingredient containers;
a container transfer apparatus configured to move a closed ingredient container, said container transfer apparatus comprising:
a gripper mechanism comprising a rigid component as a support component and one or more grippers, said gripper mechanism being configured to grip a closed ingredient container; and
a motion mechanism configured to move the support component of the gripper mechanism, said motion mechanism comprising a motor or other driving mechanism;
a cooking station configured to be located outside of the storage room, said cooking station comprising:
a cookware configured to contain or otherwise hold food or food ingredients;
a motion mechanism configured to move the cookware, said motion mechanism comprising a motor or other driving mechanism: and
a dispensing apparatus configured to move a said ingredient container as to dispense food or food ingredients from the ingredient container to the cookware, said dispensing apparatus comprising:
a gripper mechanism comprising a support component and one or more grippers, said gripper mechanism being configured to grip an ingredient container; and
a motion mechanism configured to move the support component of the gripper mechanism, said motion mechanism comprising a motor or other driving mechanism; and
a plurality of vehicles each configured to transport one or more said ingredient containers from station to station.

14. The kitchen system of claim 14, wherein the motion mechanism of the container transfer apparatus of the storage station comprises:
a first motion sub-mechanism comprising a moving member and a stationary member, said first motion mechanism being configured to move the moving member relative to the stationary member;
a second motion sub-mechanism comprising a moving member and a stationary member, said second motion mechanism being configured to move the moving member relative to the stationary member;
a third motion sub-mechanism comprising a moving member and a stationary member, said third motion mechanism being configured to move the moving member relative to the stationary member;
wherein the stationary member of the first motion sub-mechanism is configured to be rigidly or fixedly connected to the moving member of the second motion sub-mechanism;
wherein the stationary member of the second motion sub-mechanism is configured to be rigidly or fixedly connected to the moving member of the third motion sub-mechanism.

15. The kitchen system of claim 14, wherein the gripping mechanism of the transfer apparatus comprises a vacuum chuck as a gripper.

16. The kitchen system of claim 14, further comprising a window or other opening in between the storage room and the outside as allow a said vehicle to enter or leave the storage room.

17. The kitchen system of claim 17, further comprising a door or movable object configured to cover said window or other opening during some time period as to limit heat flow between the storage room and the outside.

18. The kitchen system of claim 14, further comprising a lid opening apparatus configured to remove a lid from a closed ingredient container, said lid opening apparatus comprising:
a container gripping mechanism comprising a support component and one or more grippers, said gripper mechanism being configured to grip an ingredient container;
a lid gripping mechanism comprising a support component and one or more grippers, said gripper mechanism being configured to grip a lid;
a motion mechanism configured to produce a relative motion between the support component of the container gripping mechanism and the support component of the lid gripping mechanism, said motion mechanism comprising a motor or other driving mechanism.

19. A kitchen system, comprising:
a plurality of ingredient containers;
a refrigerated storage room;
a cooking station located outside of the storage room, said cooking station comprising:
a cookware configured to contain or otherwise hold food or food ingredients;
a heater or stove configured to heat the cookware; and
a dispensing apparatus configured to move a said ingredient container to dispense the food ingredients from the container to the cookware, said dispensing apparatus comprising:
a gripper mechanism comprising a support component and one or more grippers, said gripper mechanism being configured to grip a said ingredient container; and
a motion mechanism configured to move the support component of the gripper mechanism, said motion mechanism comprising a motor or other driving mechanism;
a storage station located inside the storage room, said storage station comprising a container transfer apparatus comprising:
a gripper mechanism comprising a support component and one or more grippers, said gripper mechanism being configured to grip a said ingredient container; and
a motion mechanism configured to move the support component of the gripper mechanism, said motion mechanism comprising a motor or other driving mechanism;
a plurality of vehicles each configured to transport a said ingredient container from station to station; and
an opening between the storage room and the outside configured to allow a said vehicle to enter or leave the storage room.

20. The kitchen system of claim 19, further comprising rail tracks configured to connect the stations of the kitchen system, wherein the vehicles are configured to move on the rail tracks.

21. The cooking system of claim 19, wherein the storage room comprises storage compartments each configured to store said ingredient containers.

22. The kitchen system of claim 19, wherein the storage station further comprises an additional container transfer apparatus comprising:
a gripper mechanism comprising a rigid component as a support component and one or more grippers, said gripper mechanism being configured to grip an ingredient container; and
a motion mechanism configured to move the support component of the gripper mechanism, said motion mechanism comprising a motor or other driving mechanism.
